(19) United States
(12) Patent Application Publication
(10) Pub. No.: US 2026/0219531 A1
(43) Pub. Date: Jul. 30, 2026

(54) LIGHTING DEVICE AND DISPLAY DEVICE

(71) Applicant: Sharp Kabushiki Kaisha, Sakai City (JP)

(72) Inventor: Takeshi MASUDA, Sakai City (JP)

(21) Appl. No.: 19/456,090

(22) Filed: Jan. 22, 2026

(30) Foreign Application Priority Data
Jan. 24, 2025 (JP) 2025-010375
Dec. 19, 2025 (JP) 2025-266865

(51) Int. Cl. G02F 1/1335; G02F 1/1333

(52) U.S. Cl. CPC G02F 1/133553; G02F 1/133305; G02F 1/133524

(57) ABSTRACT

A lighting device includes a light source having a light emitting surface through which light exits toward a surface of a light supplied object, and a concave mirror disposed on a lateral side of the light supplied object and opposite the light emitting surface of the light source. The concave mirror has a reflection surface that reflects the light from the light source to be directed along the surface of the light supplied object.

### CROSS REFERENCE TO RELATED APPLICATION

This application claims priority from Japanese Patent Application No. 2025-010375 filed on Jan. 24, 2025 and Japanese Patent Application No. 2025-266865 filed on Dec. 19, 2025. The entire contents of the priority applications are incorporated herein by reference.

### TECHNICAL FIELD

The present technology described herein relates to a lighting device and a display device that improves uniformity of luminance.

### BACKGROUND

There has been known a lighting device for supplying light to an artwork. One example of such a lighting device includes an artwork frame that holds an artwork, and a light source and a collimating lens that are disposed inside the frame. The artwork frame includes four members and each member has two thin openings extending along the front surface of the member. The light source and the collimating lens are disposed in the thin openings of two members that are opposed to each other.

In such a lighting device, a Fresnel lens is included as the collimating lens. However, light rays exiting through the light exit surface of the Fresnel lens are less likely to be parallel to each other as they propagate farther away from the optical axis of the light source. Therefore, a some of the light rays that exit through the light exit surface of the Fresnel lens do not propagate parallel to each other and a large amount of the light rays that do not propagate parallel to each other do not reach the artwork and directly exit the glass plate. Therefore, the uniformity of luminance within a surface area of the artwork may be reduced.

### SUMMARY

The technology described herein was made in view of the above circumstances. An object is to improve uniformity of luminance.
(1) A lighting device according to the technology described herein includes a light source having a light emitting surface through which light exits toward a surface of a light supplied object, and a concave mirror disposed on a lateral side of the light supplied object and opposite the light emitting surface of the light source. The concave mirror has a reflection surface that reflects the light from the light source to be directed along the surface of the light supplied object.
(2) The lighting device may further include, in addition to (1), a reflection member that extends from the light source to the concave mirror and reflects the light.
(3) The lighting device may further include, in addition to (1) or (2), a louver that is disposed on a lateral side of the light supplied object and opposite the reflection surface. The louver may include at least two light blocking portions that are spaced away from each other in a normal direction to the surface, and a light transmissive portion that is disposed between the at least two light blocking portions.
(4) A display device according to the technology described herein includes a display panel having a display surface where an image is displayed, and a lighting device. The lighting device includes a light source having a light emitting surface through which light exits toward the display surface of the display panel, and a concave mirror disposed on a lateral side of the display panel and opposite the light emitting surface of the light source. The concave mirror has a reflection surface that reflects the light from the light source to be directed along the display surface of the display panel.
(5) In the display device, in addition to (4), the display panel may include an outer edge portion including a first edge portion. The light source and the concave mirror may be disposed on a lateral side of the first edge portion. The light source may be disposed closer to the first edge portion than the concave mirror is.
(6) The lighting device may further include, in addition to (5), a mirror surface reflection member that reflects light with specular reflection. The outer edge portion of the display panel may further include a second edge portion where the light source and the concave mirror are not disposed, and the mirror surface reflection member may be disposed on a lateral side of the second edge portion.
(7) In the display device, in addition to (6), the display panel may have a rectangular shape and the outer edge portion may include the first edge portion and three second edge portions including the second edge portion. The mirror surface reflection member may include mirror surface reflection members that are disposed on a lateral side of the three second edge portions, respectively.
(8) In the display device, in addition to (6), the display panel may include display panels including a first display panel and a second display panel and the first display panel and the second display panel may have a rectangular shape. The outer edge portion of each of the first display panel and the second display panel may include the first edge portion, two second edge portions including the second edge portion, and a third edge portion where the light source, the concave mirror, and the mirror surface member are not disposed. The first display panel and the second display panel may be disposed such that the third edge portions thereof are arranged next to each other. The mirror surface reflection member may include mirror surface reflection members that are disposed on the lateral side of the two second edge portions of each of the first display panel and the second display panel.
(9) In the display device, in addition to (6), the display panel may include display panels including a first display panel, a second display panel, a third display panel, and a fourth display panel, and the first display panel, the second display panel, the third display panel, and the fourth display panel may have a rectangular shape. The outer edge portion of each of the first display panel, the second display panel, the third display panel, and the fourth display panel may include the first edge portion, the second edge portion, and two third edge portions where the light source, the concave mirror, and the mirror surface member are not disposed. The two third edge portions may include one third edge portion and other third edge portion. The first display panel and the second display panel may be disposed such that the one third edge portions thereof are arranged next to each other. The third display panel and the fourth display panel may be disposed such that the one third edge portions thereof are arranged next to each other. The first display panel and the third display panel may be disposed such that the other third edge portions thereof are arranged next to each other. The second display panel and the fourth display panel may be disposed such that the other third edge portions thereof are arranged next to each other. The mirror surface reflection member may include mirror surface reflection members that are disposed on the lateral side of the second edge portions of the first display panel, the second display panel, the third display panel, and the fourth display panel.
(10) In the display device, in addition to (6), the display panel may include display panels including a first display panel, a second display panel, a third display panel, a fourth display panel, a fifth display panel, and a sixth display panel. The first display panel, the second display panel, the third display panel, the fourth display panel, the fifth display panel, and the sixth display panel may have a rectangular shape. The outer edge portion of each of the first display panel, the second display panel, the third display panel, and the fourth display panel may include the first edge portion, the second edge portion, and two third edge portions where the light source, the concave mirror, and the mirror surface member are not disposed. The two third edge portions may include one third edge portion and other third edge portion. The outer edge portion of each of the fifth display panel and the sixth display panel may include the first edge portion and three third edge portions where the light source, the concave mirror, and the mirror surface member are not disposed. The three third edge portions may include one third edge portion, a first opposed third edge portion, and a second opposed third edge portion. The first display panel and the second display panel may be disposed such that the one third edge portions thereof are arranged next to each other. The third display panel and the fourth display panel may be disposed such that the one third edge portions thereof are arranged next to each other. The fifth display panel and the sixth display panel may be disposed such that the one third edge portions thereof are arranged next to each other. The fifth display panel may be disposed between the first display panel and the third display panel and the sixth display panel may be disposed between the second display panel and the fourth display panel. The first display panel may be disposed such that the other third edge portion is arranged next to the first opposed third edge portion of the fifth display panel. The third display panel may be disposed such that the other third edge portion is arranged next to the second opposed third edge portion of the fifth display panel. The second display panel may be disposed such that the other edge portion is arranged next to the first opposed third edge portion of the sixth display panel. The fourth display panel may be disposed such that the other edge portion is arranged next to the second opposed third edge portion of the sixth display panel. The mirror surface reflection member may include mirror surface reflection members that are disposed on the lateral side of the second edge portions of the first display panel, the second display panel, the third display panel, and the fourth display panel.
(11) The display device may further include, in addition to any one of (4) to (10), a light transmissive panel that has an opposed surface facing the display surface and is disposed to be away from the display panel with having a space between the display surface and the opposed surface. The concave mirror may be disposed such that the reflection surface faces the space.
(12) In the display device, in addition to any one of (4) to (11), the display panel may be an electronic paper display.

According to the technology described herein, uniformity of luminance is improved.

### BRIEF DESCRIPTION OF THE DRAWINGS

FIG. 1 is a plan view of a display device of a first embodiment.

FIG. 2 is a cross-sectional view of the display device of the first embodiment along a ii-ii line in FIG. 1.

FIG. 3 is a plan view of a backplane of an electronic paper display included in the display device of the first embodiment.

FIG. 4 is a cross-sectional view illustrating a cross-sectional configuration of a display area of the electronic paper display of the first embodiment.

FIG. 5 is an enlarged cross-sectional view of a portion of the display device of the first embodiment in FIG. 2.

FIG. 6 is a cross-sectional view of a configuration of Comparative Example 1 of Comparative Experiment 1 according to the first embodiment.

FIG. 7 illustrates a table including graphs representing the angular characteristics of light from the front light device of Example 1 of Comparative Experiment 1 according to the first embodiment.

FIG. 8 illustrates a table including graphs representing the angular characteristics of light from the front light device of Comparative Example 1 of Comparative Experiment 1 according to the first embodiment.

FIG. 9 illustrates an illuminance distribution of the light from the front light device of Comparative Example 1 of Comparative Experiment 1 according to the first embodiment.

FIG. 10 illustrates an illuminance distribution of the light from the front light device of Example 1 of Comparative Experiment 1 according to the first embodiment.

FIG. 11 is a plan view of a display device of a second embodiment.

FIG. 12 is a cross-sectional view of the display device of the second embodiment along a xii-xii line in FIG. 11.

FIG. 13 is a cross-sectional view of the display device of the second embodiment along a xiii-xiii line in FIG. 11.

FIG. 14 illustrates an illuminance distribution of the light from the front light device of the display device of Comparative Example 2 of Comparative Experiment 2 according to the second embodiment.

FIG. 15 illustrates an illuminance distribution of the light from the front light device of the display device of Comparative Example 3 of Comparative Experiment 2 according to the second embodiment.

FIG. 16 illustrates an illuminance distribution of the light from the front light device of the display device of Example 2 of Comparative Experiment 2 according to the second embodiment.

FIG. 17 is a plan view of a display device of a third embodiment.

FIG. 18 is a cross-sectional view of the display device of the third embodiment along a xviii-xviii line in FIG. 17.

FIG. 19 is a cross-sectional view of the display device of the third embodiment along a xix-xix line in FIG. 17.

FIG. 20 is an enlarged cross-sectional view illustrating a portion of the display device according to the third embodiment in FIG. 18.

FIG. 21 illustrates a luminance distribution of the light from the front light device of the display device of Example 3 of Verifying Experiment 1 according to the third embodiment.

FIG. 22 illustrates a graph related to the luminance distribution of a first electronic paper display with respect to the X-axis direction according to Example 3 of Verifying Experiment 1 according to the third embodiment.

FIG. 23 illustrates a graph related to the luminance distribution of a second electronic paper display with respect to the X-axis direction according to Example 3 of Verifying Experiment 1 according to the third embodiment.

FIG. 24 is a plan view of a display device of a fourth embodiment.

FIG. 25 is a cross-sectional view of the display device of the fourth embodiment along a xxv-xxv line in FIG. 24.

FIG. 26 is a cross-sectional view of the display device of the fourth embodiment along a xxvi-xxvi line in FIG. 24.

FIG. 27 is a plan view of a display device of a fifth embodiment.

FIG. 28 is a cross-sectional view of the display device of the fifth embodiment along a xxviii-xxviii line in FIG. 27.

### DETAILED DESCRIPTION

### First Embodiment

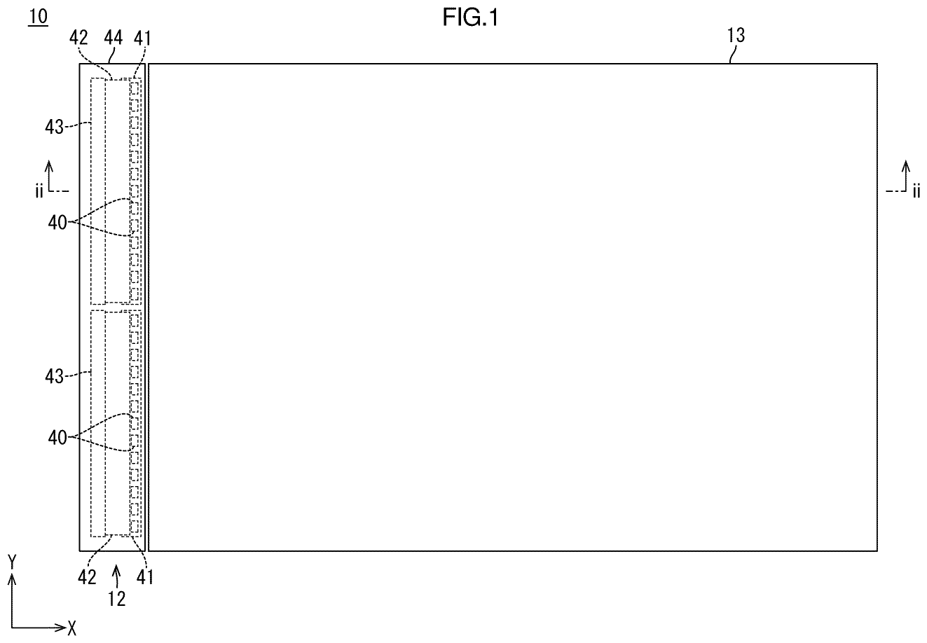

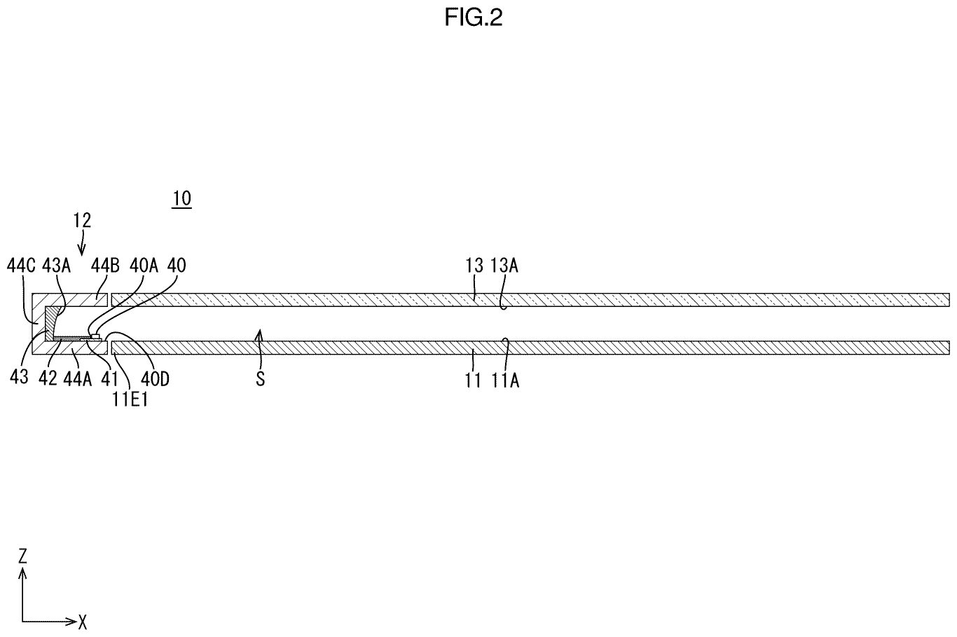

A first embodiment will be described with reference to FIGS. 1 to 10. A display device 10 that includes an electronic paper display 11 (EPD, a light supplied object) as a display panel will be described. X-axes, Y-axes, and Z-axes may be present in the drawings. The axes in each drawing correspond to the respective axes in other drawings. An upper side and a lower side in FIGS. 2, 4, and 5 correspond to a front side and a back side of the display device 10, respectively.

As illustrated in FIGS. 1 and 2, the display device 10 of this embodiment includes the electronic paper display 11 (a display panel), a front light device 12 (a lighting device) that supplies light to the electronic paper display 11 from a front side, and a light transmissive panel 13 that is disposed opposite and on the front side of the electronic paper display 11. The light transmissive panel 13 is spaced away from the electronic paper display 11.

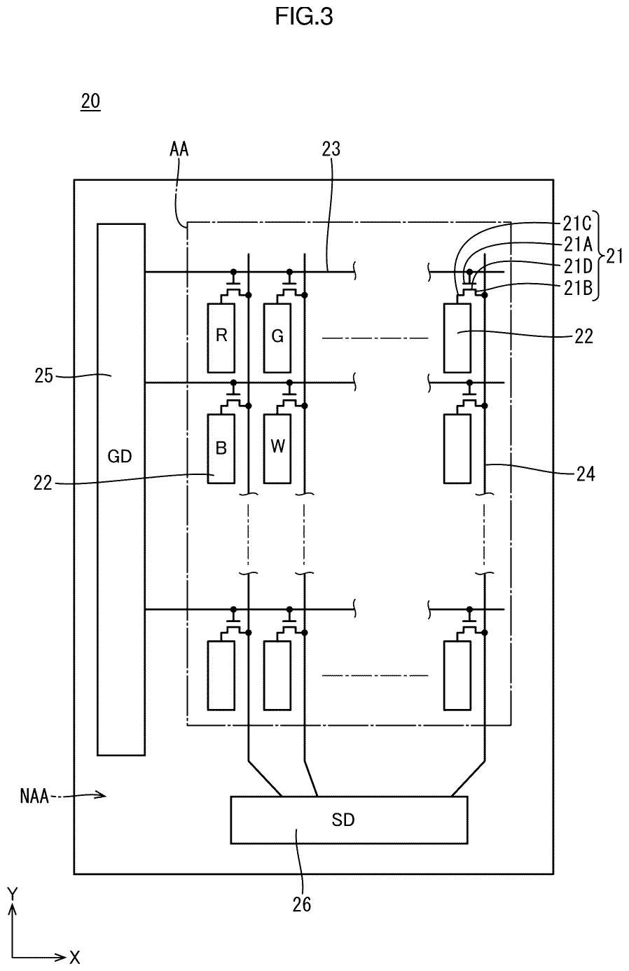

As illustrated in FIGS. 1 and 2, the electronic paper display 11 and the light transmissive panel 13 are disposed to overlap in a plan view and have a laterally elongated rectangular plan view shape. In this embodiment, the electronic paper display 11 and the light transmissive panel 13 have an A2 size. The electronic paper display 11 has a front side surface as a display surface 11A (a light supplied surface) on which images are displayed. As illustrated in FIG. 3, most area of a middle section of the display surface 11A is configured as a display area AA in which images are displayed and an outer section in a frame shape surrounding the display area AA is configured as a non-display area NAA in which images are not displayed. The display area AA has a long-side dimension of about 592 mm, for instance, and a short-side dimension of about 418 mm, for instance. The display surface 11A is a plan surface extending parallel to the X-axis direction and the Y-axis direction and a normal direction to the display surface 11A matches the Z-axis direction.

The electronic paper display 11 is a microcapsule-based electrophoretic display, for instance. The electronic paper display 11 can electrically rewrite the image displayed on the display surface 11A and keep the displayed image without being supplied with power. The electronic paper display 11 includes a backplane 20 for performing rewriting of an image. The backplane 20 has a configuration similar to the configuration of an active matrix substrate included in a liquid crystal display device.

The electric configuration of the backplane 20 will be described with reference to FIG. 3. As illustrated in FIG. 3, thin film transistors (TFTs) 21 (transistors, switching components) and pixel electrodes 22 are arranged in the display area AA of the backplane 20. The TFTs 21 and the pixel electrodes 22 are arranged at intervals in a matrix (rows and columns) along the X-axis direction and the Y-axis direction. Gate lines 23 (scanning lines) and source lines 24 (image lines, signal lines) are routed perpendicular to each other (with crossing) to surround the TFTs 21 and the pixel electrodes 22. The gate lines 23 extend along the X-axis direction and are arranged at intervals in the Y-axis direction. The source lines 24 extend along the Y-axis direction and are arranged at intervals in the X-axis direction.

As illustrated in FIG. 3, the TFT 21 includes a gate electrode 21A that is connected to the gate line 23, a source electrode 21B that is connected to the source line 24, a drain electrode 21C that is connected to the pixel electrode 22, and a semiconductor section 21D that is connected to the source electrode 21B and the drain electrode 21C and made of semiconductor material. The semiconductor material of the semiconductor section 21D may be oxide semiconductor material. The TFTs 21 are driven based on scan signals supplied to the gate electrodes 21A through the gate lines 23. The scan signals include a potential higher than threshold voltage of the TFT 21. Through the driving of the TFT 21, a channel section is created in the semiconductor section 21D and electrons move between the source electrode 21B and the drain electrode 21C via the channel section. Therefore, a potential related to the image signal (data signal) that is supplied to the source electrode 21B through the source line 24 is supplied to the drain electrode 21C via the semiconductor section 21D. As a result, the pixel electrode 22 is charged at the potential related to the pixel signal.

As illustrated in FIG. 3, a gate circuit 25 and a source driver 26 are disposed in the non-display area of the backplane 20. The gate circuit 25 is disposed adjacent to one side (a left side in FIG. 3) of the display area AA with respect to the X-axis direction. The gate circuit 25 is disposed in a belt-shaped area extending along the Y-axis direction. The gate lines 23 have extending portions that are disposed in the non-display area NAA and are connected to the gate circuit 25. The gate circuit 25 is configured to supply scanning signals to the gate lines 23. The gate circuit 25 is monolithically fabricated on the backplane 20. The gate circuit 25 is a gate driver monolithic (GDM) circuit. The gate circuit 25 is supplied with various kinds of signals transferred from a flexible substrate that is connected to the backplane 20.

As illustrated in FIG. 3, the source driver 26 is disposed adjacent to one side (a lower side in FIG. 3) of the display area AA with respect to the Y-axis direction. The source driver 26 has a laterally long rectangular plan view shape. The source lines 24 have extending portions that are disposed in the non-display area NAA and are connected to the source driver 26. The source driver 26 is configured to supply image signals to the source lines 24. The source driver 26 is an LSI chip that includes a driver circuit therein. The source driver 26 is mounted on the backplane 20. The source driver 26 processes various kinds of signals that are transferred from the flexible substrate that is connected to the backplane 20.

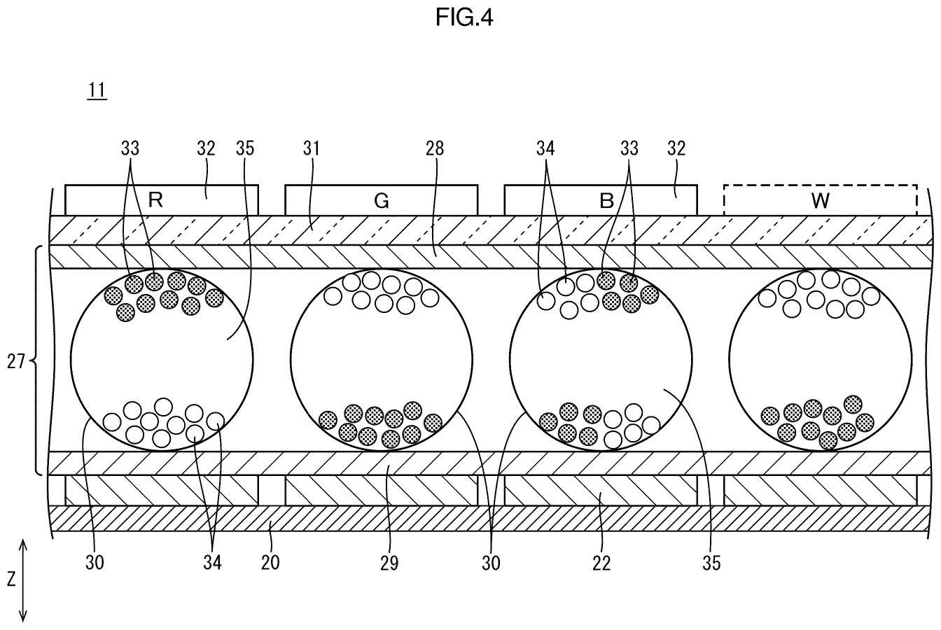

A cross-sectional configuration of the display area AA of the electronic paper display 11 will be described with reference to FIG. 4. As illustrated in FIG. 4, the electronic paper display 11 includes the backplane 20 and an electronic paper layer 27 (a display layer) that is disposed on the front side of the backplane 20 to overlap the backplane 20. The backplane 20 and the electronic paper layer 27 are bonded with an adhesive layer. The electronic paper layer 27 may be referred to as a front panel laminate (FPL). The electronic paper layer 27 includes two films 28, 29, microcapsules 30 disposed between the two films 28, 29, and a transparent electrode 31 (an opposed electrode) that is disposed on a front side of the film 28, and color filters 32. The transparent electrode 31 is disposed on a front side of the film 28, which is a front one (upper one in FIG. 4) of the two films, and the color filters 32 are disposed on a front side of the transparent electrode 31.

A detailed configuration of the electronic paper layer 27 will be described. The films 28, 29 of the electronic paper layer 27 are made of transparent synthetic resin material. As illustrated in FIG. 4, the films 28, 29 are disposed to be opposed to each other with having a predefined distance therebetween with respect to the Z-axis direction. The microcapsules 30 are arranged in a single layer between the films 28, 29. The microcapsules 30 are disposed to overlap one pixel electrode 22 of the backplane 20. The microcapsule 30 includes at least black particles 33 exhibiting black and white particles 34 exhibiting white as charged particles. The black particles 33 are carbon black particles that are negatively charged. The white particles 34 are titanium oxide particles that are positively charged. The microcapsule 30 includes insulating fluid 35 in which the black particles 33 and the white particles 34 are dispersed. An example of the insulating fluid 35 is silicone oil.

The transparent electrode 31 is made of transparent electrode material such as indium tin oxide (ITO). The transparent electrode 31 is disposed in a solid manner to extend at least in an entire area of the display area AA and overlaps all the pixel electrodes 22 included in the backplane 20. External light entering the electronic paper layer 27 from the front side passes through the films 28, 29 and the transparent electrode 31. The color filters 32 exhibit three different colors of red (R), green (G), and blue (B). The color filters 32 are disposed to overlap the corresponding pixel electrodes 22 of the backplane 20, respectively. The color filter 32 and the corresponding pixel electrode 22 that are overlapped are configured as a pixel, which is a display unit. The color filters 32 exhibiting red and the corresponding pixel electrodes 22 are configured as red pixels (R). The color filters 32 exhibiting green and the corresponding pixel electrodes 22 are configured as green pixels (G). The color filters 32 exhibiting blue and the corresponding pixel electrodes 22 are configured as blue pixels (B). The pixel electrodes 22 that do not overlap the color filters 32 are configured as white pixels (W) that exhibit white.

As illustrated in FIG. 4, the pixel electrodes 22 are charged at a predefined potential or not charged. Then, a potential difference is created according to the potential of each pixel electrode 22 between the pixel electrode 22 and the transparent electrode 31. With a negative electric field relative to the transparent electrode 31 being applied to one of the pixel electrodes 22 (the pixel electrode 22 on the left end in FIG. 4), the negatively charged black particles 33 move to the front side portion of the microcapsule 30 due to a repulsion force. The positively charged white particles 34 move to the back side portion of the microcapsule 30 due to an attraction force. As a result, the light entering the electronic paper layer 27 from the front side is absorbed by the black particles 33 in the front side portion of the microcapsule 30. Accordingly, the microcapsule 30, which is disposed on the left side in FIG. 4, exhibits black. Thus, even with the color filter 32 being disposed, the color corresponding to the color filter 32 is not displayed but black is exhibited in a portion of the display surface 11A overlapping the microcapsule 30 exhibiting black.

On the other hand, with a positive electric field relative to the transparent electrode 31 being applied to another one of the pixel electrodes 22 (the second one from the left side in FIG. 4 and the pixel electrode 22 on the right end in FIG. 4), the positively charged white particles 34 move to the front side portion of the microcapsule 30 due to a repulsion force. The negatively charged black particles 33 move to the back side portion of the microcapsule 30 due to an attraction force. As a result, the light entering the electronic paper layer 27 from the front side is reflected by the white particles 34 in the front side portion of the microcapsule 30. Accordingly, the microcapsule 30 overlapping the white pixel (W) without having the color filter 32 exhibits white and white is displayed in a corresponding portion of the display surface 11A. The microcapsule 30 overlapping the pixel (R), (G), (B) exhibits the color corresponding to the color filter 32 and the color is displayed in a corresponding portion of the display surface 11A.

With other one of the pixel electrodes 22 (the second one from the right end in FIG. 4) being not charged and no electric filed being applied to the pixel electrode 22, both of the black particles 33 and the white particles 34 are in the front side portion and in the back side portion of the microcapsule 30. The light entering the electronic paper layer 27 from the front side is absorbed by the black particles 33 in the front side portion of the microcapsule 30 and reflected by the white particles 34 in the front side portion of the microcapsule 30. Accordingly, the microcapsules 30, which are disposed on the second one from the right end in FIG. 4, exhibits gray. Thus, color images are displayed on the display surface 11A.

As illustrated in FIGS. 1 and 2, the light transmissive panel 13 has a substantially same size as the electronic paper display 11. The light transmissive panel 13 is made of glass material or synthetic resin material (acrylic material, for instance) and is almost transparent and has good light transmissive properties. The light transmissive panel 13 is held by a holding member so as to be disposed on the front side of and spaced from the electronic paper display 11 with a predefined distance. The light transmissive panel 13 has an opposed surface 13A that faces the display surface 11A of the electronic paper display 11. The light transmissive panel 13 has a thickness of about 3 mm. A space S is between the opposed surface 13A of the light transmissive panel 13 and the display surface 11A of the electronic paper display 11. The distance between the opposed surface 13A and the display surface 11A (a thickness dimension of the space S) is about 10 mm, for instance. Air is in the space S.

As illustrated in FIGS. 1 and 2, the front light device 12 includes LEDs 40 (a light source), a LED board 41 (a light source board), a reflection sheet 42 (a reflection member), a concave mirror 43, and a casing 44. The LEDs 40 have light emitting surfaces 40A through which light exits. The LEDs 40 are mounted on the LED board 41. The light from the LEDs 40 reflects off the reflection sheet 42. The light from the LEDs 40 reflects off the concave mirror 43. The LED 40s, the LED board 41, the reflection sheet 42, and the concave mirror 43 are arranged in the casing 44. The LEDs 40, the LED board 41, the reflection sheet 42, the concave mirror 43, and the casing 44 of the front light device 12 are disposed on a lateral side of and next to a first edge portion 11E1 (a left short-side edge portion in FIGS. 1 and 2) of an outer edge portion of the electronic paper display 11.

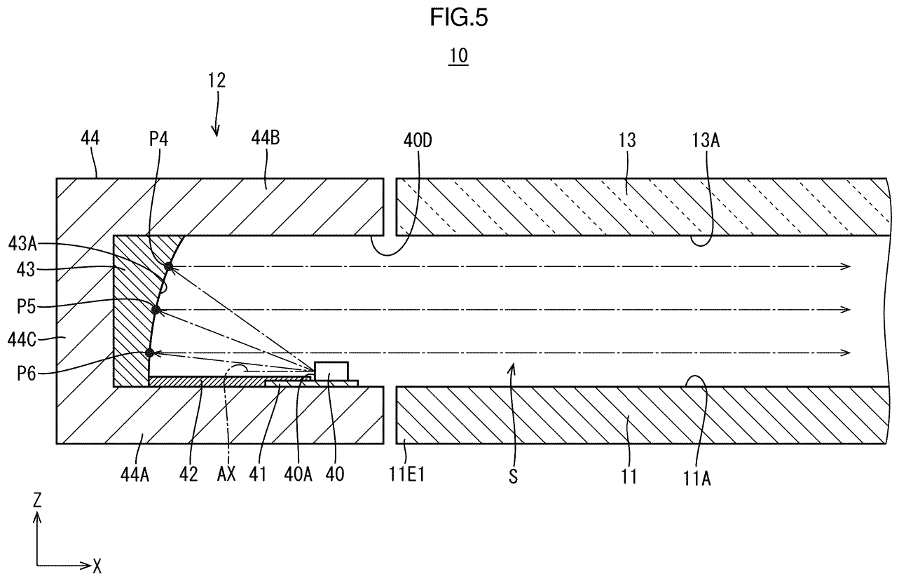

As illustrated in FIG. 1, the casing 44 is made of synthetic resin material and extends along the Y-axis direction and has a vertically elongated rectangular shape. As illustrated in FIG. 2, the casing 44 has a cross-sectional C-shape as a whole. The casing 44 includes a first casing body portion 44A, a second casing body portion 44B that is opposed to the first casing body portion 44A with a space therebetween, and a third casing body portion 44C that is continuous to the first casing body portion 44A and the second casing body portion 44B. As illustrated in FIG. 5, the first casing body portion 44A and the second casing body portion 44B have opposing surfaces that are parallel to the display surface 11A. The first casing body portion 44A is disposed on the rear side of the second casing body portion 44B with having a space therebetween. The third casing body portion 44C has an opposing surface that extends along the Y-axis direction and the Z-axis direction. The third casing body portion 44C has a plate shape that is vertical to the display surface 11A. The third casing body portion 44C has a rear edge portion and a front edge portion with respect to the Z-axis direction. The rear edge portion of the third casing body portion 44C is continuous to an edge portion (a left edge portion in FIG. 2) of the first casing body portion 44A that is an opposite side from the electronic paper display 11. The front edge portion of the third casing body portion 44C is continuous to an edge portion (a left edge portion in FIG. 2) of the second casing body portion 44B that is an opposite side from the electronic paper display 11. The casing 44 has an opening 44D at the edge portions (right edge portions in FIG. 2) of the first casing body portion 44A and the second casing body portion 44B close to the electronic paper display 11. The opening 44D opens toward the space S between the electronic paper display 11 and the light transmissive panel 13. An inner space of the casing 44 is defined by the he first casing body portion 44A, the second casing body portion 44B, and the third casing body portion 44C. The inner space of the casing 44 is continuous to the space S between the electronic paper display 11 and the light transmissive panel 13 via the opening 44D.

As illustrated in FIG. 2, the LED 40 is a so-called side surface emitting LED and has the light emitting surface 40A on a side surface of the LED 40 next to a bottom surface that is contacted with the LED board 41. The light emitting surface 40A of the LED 40 extends along the Y-axis direction and the Z-axis direction and a normal direction of the light emitting surface 40A matches the X-axis direction. An optical axis AX of the LED 40 extends along the X-axis direction. The optical axis is referred to as an axis that matches the direction in which the light rays having highest emission intensity (a peak) among the light rays emitted by the LED 40 propagate. The LED 40 has a light distribution that extends in a fan shape and spreads in the Y-axis direction (a horizontal direction) and the Z-axis direction (a vertical direction) with respect to the optical axis AX. As illustrated in FIG. 5, the LED 40 is disposed such that the light emitting surface 40A faces the opposite side from the electronic paper display 11 (faces the left side in FIG. 5 or the third casing body portion 44C and the concave mirror 43) with respect to the X-axis direction. The LED 40 is disposed closer to the first edge portion 11E1 of the electronic paper display 11 than the concave mirror 43 is. The LED 40 includes an LED chip that is sealed on a base plate with sealing material. The base plate is fixed to the LED board 41. The LED chip included in the LED 40 emits light of a single color of blue, for instance. Phosphors are dispersed in the sealing material of the LEDs 40. Examples of the phosphors included in the sealing material include yellow phosphors, green phosphors, and red phosphors. The LED 40 including the LED chip and the sealing material emits white light as a whole.

The LED board 41 includes a flexible printed circuit film that is made of insulating material and has flexibility and a metal foil that is made of copper and includes multiple traces and disposed on the flexible printed circuit film. As illustrated in FIGS. 1 and 2, the LED board 41 has a long belt shape extending along the Y-axis direction. On the LED board 41, the LEDs 40 are arranged in one row along the extending direction in which the LED board 41 extends (the Y-axis direction). The LEDs 40 may be arranged at equal intervals. As illustrated in FIG. 5, the LED board 41 is attached to an inner surface (the opposing surface facing the second casing body portion 44B) of the first casing body portion 44A of the casing 44 such that the mount surface extends parallel to the display surface 11A. As illustrated in FIG. 1, two LED boards 41 are arranged in the Y-axis direction on the inner surface of the first casing body portion 44A. The LEDs 40 mounted on each of the two LED boards 41 are arranged in a row. The LED board 41 includes an extending portion that extends outside the casing 44 and is connected to power supply and the LED 40 is supplied with power.

The reflection sheet 42 has a film shape and specular reflection of light occurs on the surface of the reflection sheet 42. As illustrated in FIGS. 1 and 2, the reflection sheet 42 has a long belt shape extending along the Y-axis direction similar to the LED board 41 and has a length dimension (dimension measured in the Y-axis direction) that is same as the length dimension of the LED board 41. As illustrated in FIG. 5, the reflection sheet 42 is attached to the inner surface (the opposing surface facing the second casing body portion 44B) of the first casing body portion 44A of the casing 44 similar to the LED board 41 such that the surface extends parallel to the display surface 11A. The reflection sheet 42 has a width extending along the X-axis direction from the LEDs 40 to the concave mirror 43. A portion of the reflection sheet 42 overlaps the LED board 41. The light rays that exit through the light emitting surface 40A of the LED 40 and propagate obliquely downward reflect off the reflection sheet 42 (with specular reflection) toward the concave mirror 43. This improves use efficiency of the light rays. The reflection sheet 42 is disposed to extend continuously along all the LEDs 40 mounted on the LED board 41. Namely, the reflection sheet 42 extends between every two LEDs 40 that are adjacent to each other in the Y-axis direction. Therefore, the light rays that exit through the light emitting surface 40A of the LED 40 and propagate obliquely with respect to the Y-axis direction reflect off the reflection sheet 42 (with specular reflection). Similar to the LED boards 41, two reflection sheets 42 are arranged in the Y-axis direction on the inner surface of the first casing body portion 44A.

The concave mirror 43 is formed from a substrate made of glass material or synthetic resin material. A recess is formed on the substrate and a metal film (such as an aluminum film) is disposed on the recess with deposition. Thus, a reflection surface 43A, which reflects light, is formed. As illustrated in FIG. 2, the concave mirror 43 is disposed on the lateral side of the electronic paper display 11 and opposite the light emitting surface 40A of the LED 40. Specifically, the concave mirror 43 is attached to the inner surface (the surface facing the opening 44D) of the third casing body portion 44C of the casing 44 such that the reflection surface 43A faces the light emitting surfaces 40A of the LEDs 40. The reflection surface 43A is exposed to the space S between the electronic paper display 11 and the light transmissive panel 13 through the opening 44D. With such a configuration, some of the light rays exiting through the light emitting surfaces 40A of the LEDs 40 directly reflect off the reflection surface 43A and some of the light rays exiting through the light emitting surfaces 40A reflect off the reflection sheet 42 (specular reflection) and indirectly reflect off the reflection surface 43A. The light rays reflected by the reflection surface 43A propagate toward the space S between the electronic paper display 11 and the light transmissive panel 13 through the opening 44D. The concave mirror 43 is disposed farther away from the first edge portion 11E1 of the electronic paper display 11 than the LEDs 40 are. Therefore, the light rays that exit through the light emitting surfaces 40A of the LEDs 40, which are close to the first edge portion 11E1, are reflected by the concave mirror 43 toward the display surface 11A. The concave mirror 43 has a width dimension measured in the Z-axis direction that is almost same as the width dimension of the third casing body portion 44C measured in the Z-axis direction. As illustrated in FIG. 1, the concave mirror extends along the Y-axis direction and has a length dimension measured in the Y-axis direction that is almost same as the length dimension of the LED board 41 measured in the Y-axis direction. The concave mirror 43 is disposed such that the reflection surface 43A extends to face all of the LEDs 40 mounted on the LED board 41. Namely, the concave mirror 43 extends between every two LEDs 40 that are adjacent to each other in the Y-axis direction. Therefore, the light rays that exit through the light emitting surfaces 40A of the LEDs 40 and propagate obliquely with respect to the Y-axis direction reflect off the reflection surface 43A. Similar to the LED boards 41, two concave mirrors 43 are arranged in the Y-axis direction on the inner surface of the third casing body portion 44C.

As illustrated in FIG. 5, the concave mirror 43 is disposed such that the focal point of the reflection surface 43A is on the light emitting surface 40A of the LED 40. The reflection surface 43A of the concave mirror 43 is a non-spherical surface such as a paraboloid to eliminate spherical aberration. More specifically, the concave mirror 43 is formed such that the reflection surface 43A is curved closer to the LED 40 (rightward in FIG. 5) as it extends farther away from the LED 40 with respect to the Z-axis direction (extends upward in FIG. 5) and recessed toward the third casing body portion 44C as it extends closer to the LED 40 with respect to the Z-axis direction (extends downward in FIG. 5). The concave mirror 43 has a recessed shape as a whole. With such a configuration, the light rays exiting through the light emitting surface 40A, which has a focal point, are reflected by the reflection surface 43A and the reflected light rays are aligned in a parallel direction. The parallel light rays included in the light rays reflected by the reflection surface 43A propagate along the display surface 11A (the X-axis direction).

According to such a configuration, the light rays exiting through the light emitting surface 40A of the LED 40 are reflected by the reflection surface 43A of the concave mirror 43, which is disposed opposite the light emitting surface 40A and on the lateral side of the electronic paper display 11, and are supplied to the display surface 11A of the electronic paper display 11. The concave mirror 43 is configured such that the light rays reflecting off the reflection surface 43A propagate along the display surface 11A of the electronic paper display 11. Therefore, difference between the amounts of light rays supplied to the portion of the display surface 11A close to the concave mirror 43 and supplied to the portion of the display surface 11A far away from the concave mirror 43 is reduced. Particularly, compared to a Fresnel lens, light rays reflecting off the reflection surface 43A of the concave mirror 43 are likely to be aligned in a parallel direction even with being away from the optical axis AX of the LED 40. Therefore, a greater amount of light rays can be supplied to the portion of the display surface 11A far away from the concave mirror 43 and the light rays are less likely to exit the casing 44 near the concave mirror 43 without being supplied to the display surface 11A. Accordingly, uniformity of luminance (illuminance) within the display surface 11A of the electronic paper display 11 can be improved and display quality of an image displayed on the display surface 11A can be improved.

Furthermore, as illustrated in FIG. 5, this embodiment includes the reflection sheet 42 that extends from the LEDs 40 to the concave mirror 43. Some of the light rays exiting through the light emitting surface 40A of the LED 40 do not directly propagate to the reflection surface 43A. Such light rays can be reflected by the reflection sheet 42 to the reflection surface 43A of the concave mirror 43. Accordingly, light use efficiency can be improved.

In this embodiment, as illustrated in FIG. 5, the concave mirror 43 is disposed such that the reflection surface 43A faces the space S between the display surface 11A of the electronic paper display 11 and the opposed surface 13A of the light transmissive panel 13. With such a configuration, the light rays reflected by the reflection surface 43A of the concave mirror 43 propagate along the display surface 11A in the space S between the display surface 11A of the electronic paper display 11 and the opposed surface 13A of the light transmissive panel 13. Some of the light rays reflected by the reflection surface 43A are reflected by the opposed surface 13A of the light transmissive panel 13 and supplied to the display surface 11A of the electronic paper display 11. The image displayed on the display surface 11A is seen by a user through the light transmissive panel 13. The light transmissive panel 13 accelerates light supply to the display surface 11A of the electronic paper display 11 and this improves light use efficiency. External light entering through the light transmissive panel 13 can be used for displaying an image.

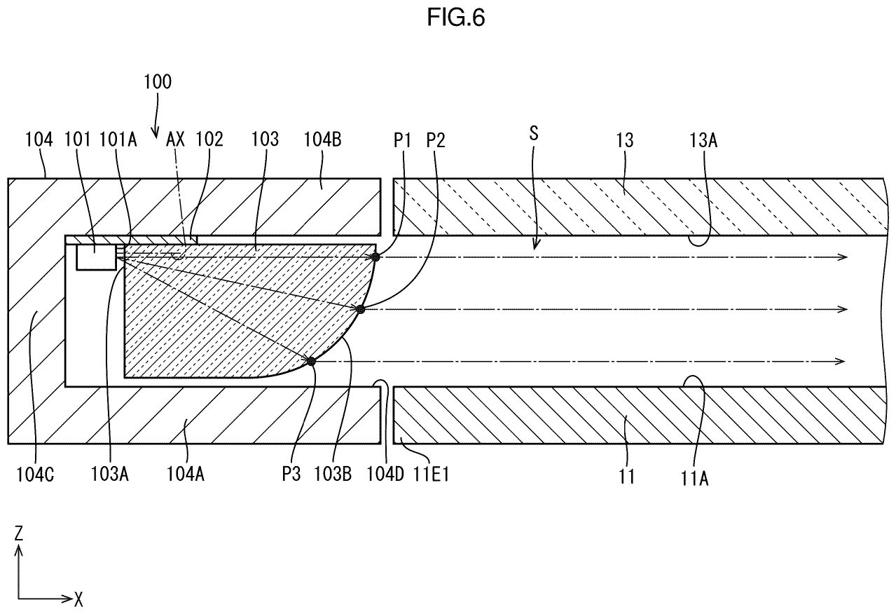

Comparative Experiment 1 was performed to verify superiority of the front light device 12 of this embodiment. In Comparative Experiment 1, simulations of supplying light from the front light device 12 of Example 1 to the electronic paper display 11 and supplying light from a front light device 100 of Comparative Example 1 to the electronic paper display 11 were performed with using a computer and the angular characteristics with respect to the supplied light and an illuminance distribution of the supplied light were obtained. In Example 1, the front light device 12 of this embodiment was used. As illustrated in FIG. 6, the front light device 100 of Comparative Example 1 includes LEDs 101, a LED board 102 on which the LEDs 101 are mounted, a lens 103 that the light from the LEDs 101 enters, and a casing 104 in which the LEDs 101, the LED board 102, and the lens 103 are arranged.

The configuration of the front light device 100 of Comparative Example 1 will be described. The casing 104 has a configuration similar to that of the casing 44 of Example 1. The casing 104 includes a first casing body portion 104A, a second casing body portion 104B, a third casing body portion 104C, and an opening 104D. The LED board 102 is attached to an inner surface of the second casing body portion 104B. The LEDs 101 are disposed farther away from the first edge portion 11E1 of the electronic paper display 11 than the lens 103 is. The LED 101 is a so-called side surface emitting LED and has a light emitting surface 101A that faces an opposite side from the third casing body portion 104C (faces the right side in FIG. 6 or the electronic paper display 11). The lens 103 is disposed closer to the first edge portion 11E1 of the electronic paper display 11 than the LEDs 101 are. The lens 103 includes a light entrance surface 103A that faces the light emitting surface 101A of the LED 101 and a light exit surface 103B that faces the space S. The light entrance surface 103A of the lens 103 is substantially parallel to the light emitting surface 101A of the LED 101. The light exit surface 103B of the lens 103 is a non-spherical surface to eliminate spherical aberration. The light rays exiting through the light exit surface 103B propagate in a parallel direction. Namely, the lens 103 is a collimating lens. Specifically, the lens 103 is formed such that the light exit surface 103B is curved closer to the LED 101 (leftward in FIG. 6) as it extends farther away from the LED 101 with respect to the Z-axis direction (extends downward in FIG. 6) and curved closer to the electronic paper display 11 (rightward in FIG. 6) as it extends closer to the LED 101 with respect to the Z-axis direction (extends upward in FIG. 6). The lens 103 has a convex shape as a whole.

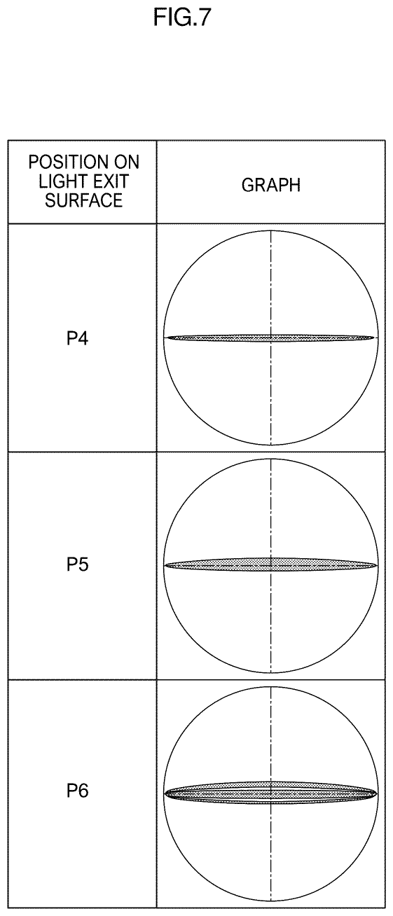

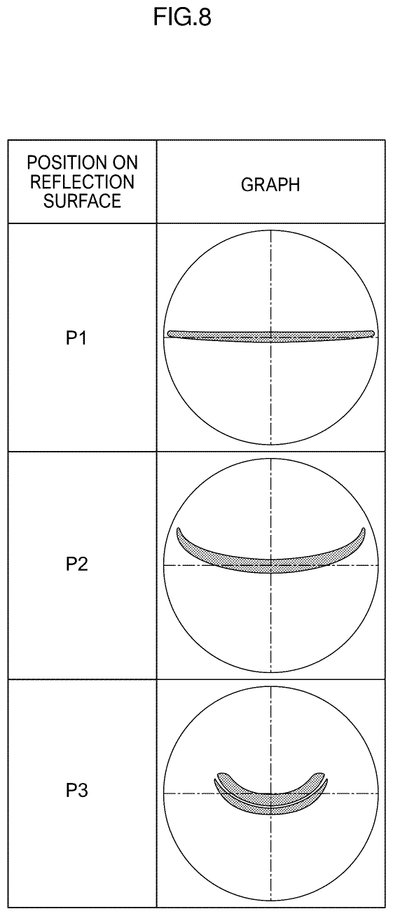

Experiment Result of Comparative Experiment 1 is illustrated in FIGS. 7 to 10. FIG. 7 is a table including graphs representing the angular characteristics of light from the front light device 12 of Example 1. FIG. 8 is a table including graphs representing the angular characteristics of light from the front light device 100 of Comparative Example 1. The table in FIG. 8 illustrates the angular characteristics of the light exiting through three different positions (a first position P1, a second position P2, a third position P3 illustrated in FIG. 6) of the light exit surface 103B of the lens 103 with respect to the Z-axis direction. As illustrated in FIG. 6, the first position P1 is adjacent to an upper edge of the light exit surface 103B in the Z-axis direction and closest to the optical axis AX. The second position P2 is adjacent to a middle of the light exit surface 103B in the Z-axis direction and is a second closest one to the optical axis AX. The third position P3 is adjacent to a lower edge of the light exit surface 103B in the Z-axis direction and farthest from the optical axis AX. The table in FIG. 7 illustrates the angular characteristics of the light exiting through three different positions (a fourth position P4, a fifth position P5, a sixth position P6 illustrated in FIG. 5) of the reflection surface 43A of the concave mirror 43 with respect to the Z-axis direction. As illustrated in FIG. 5, the fourth position P4 is adjacent to an upper edge of the reflection surface 43A in the Z-axis direction and farthest from the optical axis AX. The fifth position P5 is adjacent to a middle of the reflection surface 43A in the Z-axis direction and is a second closest one to the optical axis AX. The sixth position P6 is adjacent to a lower edge of the reflection surface 43A in the Z-axis direction and closest to the optical axis AX.

Each of the graphs illustrated in the tables in FIGS. 7 and 8 represents a beam angle range of the light rays, which is illustrated with shading. In each of the graphs in the tables in FIGS. 7 and 8, a lateral axis illustrated with a long dashed dotted line matches the Y-axis in FIGS. 5 and 6. In each of the graphs in the tables in FIGS. 7 and 8, a vertical axis illustrated with a long dashed dotted line matches the Z-axis in FIGS. 5 and 6. In each of the graphs in the tables in FIGS. 7 and 8, an intersection of the lateral axis and the vertical axis illustrated with long dashed dotted lines match the optical axis AX of the LED 40, 101.

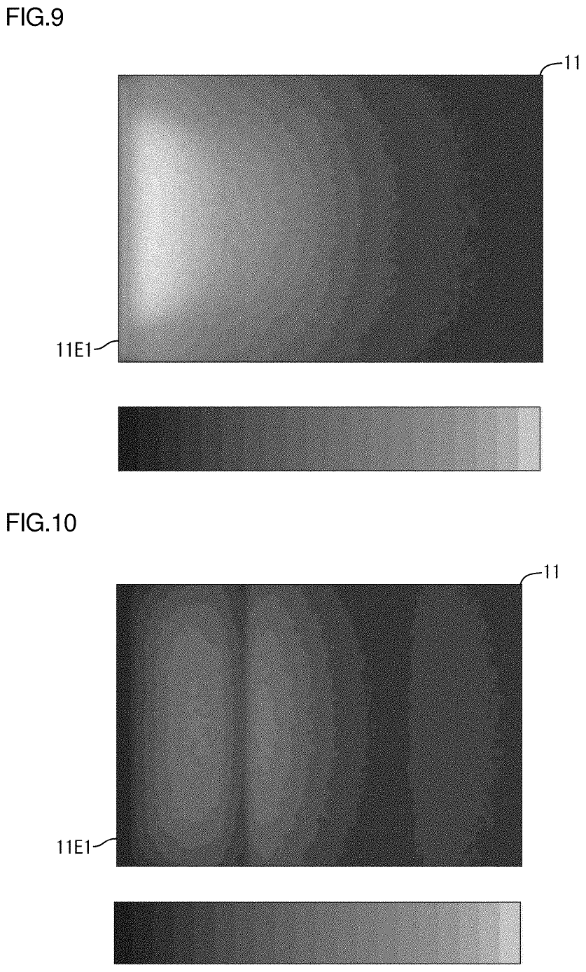

Each of FIGS. 9 and 10 illustrates an illuminance distribution within a surface area of the display surface 11A of the electronic paper display 11 that is to be supplied with light from the front light device 100, 12 of Comparative Example 1 and Example 1. The illuminance distribution illustrated in FIGS. 9 and 10 was made by performing simulation of supplying light to the display surface 11A of the electronic paper display 11 with all the LEDs 101, 40 of the front light device 100, 12 being ON. The level of illuminance is described with a degree of shading. A sample of an illuminance distribution is below the illuminance distribution in FIG. 9 and FIG. 10. In the sample, the shading becomes brighter (closer to white) as the illuminance becomes higher and the shading becomes darker (closer to black) as the illuminance becomes lower. In FIGS. 9 and 10, the left end portion of the electronic paper display 11 corresponds to the first edge portion 11E1 that is adjacent to the front light device 100, 12. FIG. 9 illustrates an illuminance distribution of the light from the front light device 100 of Comparative Example 1. FIG. 10 illustrates an illuminance distribution of the light from the front light device 12 of Example 1.

Experiment result of Comparative Experiment 1 will be described. With reference to FIG. 8, in Comparative Example 1, the parallel alignment of the light rays is maintained in the first position P1, which is closest to the optical axis AX. In the second position P2, some of the light rays that propagate in the right and left directions in the Y-axis direction (an oblique direction with respect to the horizontal direction) with respect to the optical axis AX propagate upward with respect to the Z-axis direction. In the third position P3, most of the light rays that propagate in the right and left directions in the Y-axis direction with respect to the optical axis AX propagate upward with respect to the Z-axis direction. Namely, in Comparative Example 1, the light rays exiting through the light exit surface 103B of the lens 103 are less likely to be aligned in the parallel direction as they are farther away from the optical axis AX. This may occur in Comparative Example 1 due to the following characteristics of the lens 103 (an optical component) that determines the direction in which the light rays propagate. Some of the light rays travelling toward the light exit surface 103B within the lens 103 travel in the right and left directions in the Y-axis direction with respect to the optical axis AX and are less likely to propagate in the parallel direction when exiting the lens 103 due to the travelling angle with respect to the optical axis X. As a result, the light rays propagate upward with respect to the Z-axis direction. On the other hand, with reference to FIG. 7, in Example 1, the parallel alignment of the light rays is effectively maintained on the sixth position P6, which is closest to the optical axis AX, on the fifth position P5, and on the fourth position P4, which is farthest from the optical axis AX. Namely, in Example 1, regardless of the position relation with respect to the optical axis AX, the light rays reflected by the reflection surface 43A of the concave mirror 43 surely propagate in the parallel direction. This may occur in Example 1 due to the following characteristics of the concave mirror 43 (an optical component) that determines the direction in which the light rays propagate. Some of the light rays directed toward the reflection surface 43A may propagate in the right and left directions in the Y-axis direction with respect to the optical axis AX with being angled with respect to the optical axis AX. Even with the light rays propagating with being angled with respect to the optical axis AX, such light rays are likely to propagate in the parallel direction unlike the light ryas exiting the lens 103 of Comparative Example 1.

With reference to FIG. 9, in Comparative Example 1, in the portion of the display surface 11A of the electronic paper display 11 close to the first edge portion 11E1 (the LEDs 101) with respect to the X-axis direction, the illuminance is obviously high and becomes lower as is farther away from the portion close to the first edge portion 11E1 and the illuminance is lowest in the portion farther from the first edge portion 11E1 (the LEDs 101). Namely, in Comparative Example 1, the illuminance distribution is not uniform and uniformity of luminance is low. This is caused because the light from the front light device 100 includes a large amount of light rays directed upward in the Z-axis direction as is obvious from the experiment result in FIG. 8 and the light rays directed upward directly exit outside through the light transmissive panel 13. On the other hand, with reference to FIG. 10, in Example 1, there is almost no difference in illuminance between the portion of the display surface 11A of the electronic paper display 11 close to the first edge portion 11E1 (the LED 40) and the portion of the display surface 11A far from the first edge portion 11E1 (the LED 40). Namely, in Example 1, the illuminance distribution is close to uniform and uniformity of luminance is effectively high. This is obtained because the light from the front light device 12 includes few amount of light rays directed upward in the Z-axis direction as is obvious from the experiment result in FIG. 7.

As previously described, the front light device 12 (the lighting device) of this embodiment includes the LED 40 (a light source) having the light emitting surface 40A through which light exits to the display surface 11A (a light supplied surface) of the electronic paper display 11 (a light supplied object) and the concave mirror 43 that is disposed on a lateral side of the electronic paper display 11 (the light supplied object) and opposite the light emitting surface 40A of the LED 40. The concave mirror 43 has the reflection surface 43A that reflects light to propagate along the display surface 11A (the light supplied surface).

The light exiting through the light emitting surface 40A of the LED 40 is reflected by the reflection surface 43A of the concave mirror 43 that is disposed on the lateral side of the electronic paper display 11 (the light supplied object) and opposite the light emitting surface 40A of the LED 40 and the reflected light is supplied to the display surface 11A (the light supplied surface) of the electronic paper display 11 (the light supplied object). The concave mirror 43 is configured such that the light reflected by the reflection surface 43A propagates along the display surface 11A (the light supplied surface) of the electronic paper display 11 (the light supplied object). Therefore, difference is less likely to be caused between the amount of light rays supplied to the portion of the display surface 11A (the light supplied surface) close to the concave mirror 43 and the portion of the display surface 11A (the light supplied surface) far away from the concave mirror 43. Particularly, compared to a Fresnel lens, light rays reflecting off the reflection surface 43A of the concave mirror 43 are likely to be aligned in a parallel direction even with being away from the optical axis AX of the LED 40. Therefore, a greater amount of light rays can be supplied to the portion of the display surface 11A far away from the concave mirror 43 and the light rays are less likely to exit the casing 44 near the concave mirror 43 without being supplied to the display surface 11A (the light supplied surface). Accordingly, uniformity of luminance within the display surface 11A (the light supplied surface) of the electronic paper display 11 (the light supplied object) can be improved.

The front light device 12 further includes the reflection sheet 42 (the reflection member) that extends from the LEDs 40 to the concave mirror 43 and reflects light. Some of the light rays exiting through the light emitting surface 40A of the LED 40 is reflected by the reflection sheet 42 to the reflection surface 43A of the concave mirror 43. Accordingly, light use efficiency can be improved.

The display device 10 of this embodiment includes the front light device 12 and the electronic paper display 11 (the display panel) that displays an image with using light from the LED 40. The electronic paper display 11 is a light supplied object and includes the display surface 11A on which an image is displayed (the light supplied surface). With such a display device 10, light exiting through the light emitting surface 40A of the LED 40 is reflected by the reflection surface 43A of the concave mirror 43 and supplied to the display surface 11A of the electronic paper display 11 and used for displaying an image on the display surface 11A. Accordingly, uniformity of luminance within the display surface 11A of the electronic paper display 11 can be improved and display quality can be improved.

The LED 40 and the concave mirror 43 are disposed on a lateral side of (opposite) the first edge portion 11E1 of the outer peripheral edge portion of the electronic paper display 11 and the LED 40 is closer to the first edge portion 11E1 than the concave mirror 43 is. The light exiting through the light emitting surface 40A of the LED 40, which is disposed closer to the first edge portion 11E1 of the electronic paper display 11 than the concave mirror 43 is, is reflected by the reflection surface 43A of the concave mirror 43, which is disposed farther than the first edge portion 11E1 than the LED 40 is, and supplied to the display surface 11A.

The display device 10 further includes the light transmissive panel 13 having the opposed surface 13A that is opposite the electronic paper display 11. The light transmissive panel 13 is disposed such that the space S is between the display surface 11A and the opposed surface 13A. The concave mirror 43 is disposed such that the reflection surface 43A faces the space S. The light rays reflected by the reflection surface 43A of the concave mirror 43 propagate along the display surface 11A in the space S between the display surface 11A of the electronic paper display 11 and the opposed surface 13A of the light transmissive panel 13. Some of the light rays reflected by the reflection surface 43A are reflected by the opposed surface 13A of the light transmissive panel 13 and supplied to the display surface 11A of the electronic paper display 11. The image displayed on the display surface 11A is seen by a user through the light transmissive panel 13. The light transmissive panel 13 accelerates light supply to the display surface 11A of the electronic paper display 11 and this improves light use efficiency. External light entering through the light transmissive panel 13 can be used for displaying an image.

The display panel is the electronic paper display 11. An image can be displayed on the display surface 11A of the electronic paper display 11 with using the light supplied to the display surface 11A.

### Second Embodiment

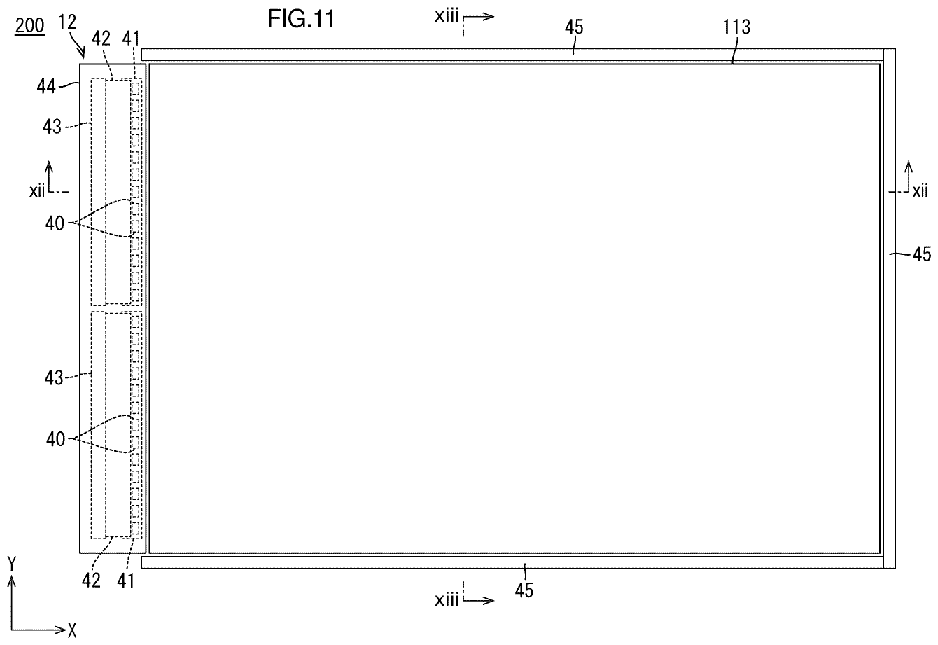

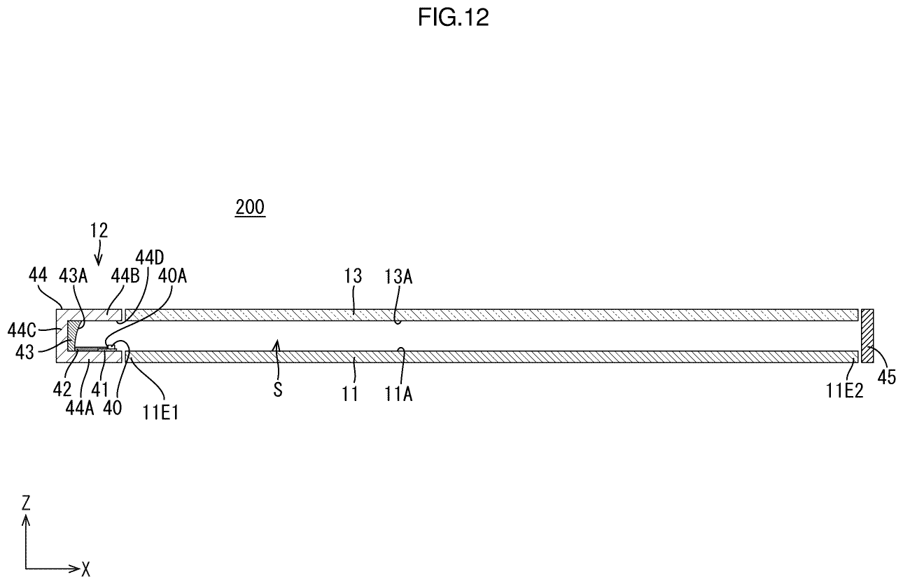

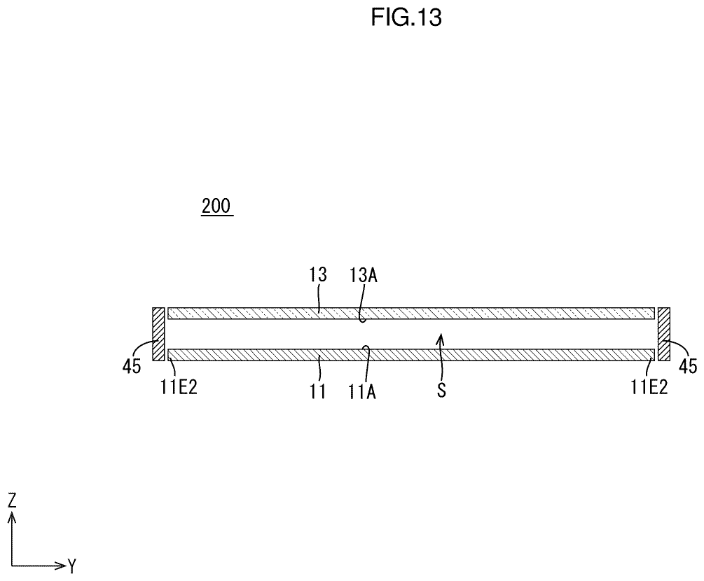

A second embodiment will be described with reference to FIGS. 11 to 16. The second embodiment includes a mirror surface reflection member 45 in addition to the first embodiment. Configurations, operations, and effects that are similar to those of the first embodiment will not be described.

As illustrated in FIGS. 11 to 13, a display device 200 of this embodiment includes mirror surface reflection members 45 that closes the space S between the electronic paper display 11 and the light transmissive panel 13. The mirror surface reflection member 45 reflects light (with specular reflection) similar to the reflection sheet 42 and has a form of a film or a plate. The mirror surface reflection member 45 has a reflection surface 45A that reflect light (with specular reflection). The mirror surface reflection member 45 is disposed such that the reflection surface 45A is vertical to the display surface 11A of the electronic paper display 11. The electronic paper display 11 has a rectangular shape and includes the outer edge portion including the first edge portion 11E1 and three second edge portions 11E2 where the LEDs 40 and the concave mirror 43 are not disposed. The mirror surface reflection member 45 is disposed on a lateral side of (opposite) the second edge portion 11E2. The display device 200 of this embodiment includes three mirror surface reflection members 45 that are disposed adjacent to the respective three second edge portions 11E2. The mirror surface reflection member 45 extends along the corresponding second edge portion 11E2 and has at least a length dimension same as the entire length of the corresponding second edge portion 11E2. The mirror surface reflection member 45 has a width dimension that is greater than the distance between the electronic paper display 11 and the light transmissive panel 13 (a thickness dimension of the space S). The mirror surface reflection member 45 that is disposed adjacent to the corresponding second edge portion 11E2 substantially closes the space S between the electronic paper display 11 and the light transmissive panel 13. The space S between the electronic paper display 11 and the light transmissive panel 13 is surrounded by the casing 44 of the front light device 12 and the three mirror surface reflection members 45. The reflection surfaces 45A of the mirror surface reflection members 45 are exposed to the space S between the electronic paper display 11 and the light transmissive panel 13.

With such a configuration, the light rays reflecting off the reflection surface 43A of the concave mirror 43 pass through the first edge portion 11E1 and enter the space S and most of the reflected light rays are supplied to the display surface 11A; however, some of the reflected light rays are not supplied to the display surface 11A but propagate through the space S and pass through the second edge portion 11E2 of the electronic paper display 11. The light rays passing through the second edge portion 11E2 reach the mirror surface reflection member 45 that is disposed opposite the second edge portion 11E2 and are reflected by the mirror surface reflection member 45 (with specular reflection). Then, the reflected light rays pass across the second edge portion 11E2 again and enter the space S and most of the reflected light rays are supplied to the display surface 11A. This improves light use efficiency and luminance of an image displayed on the display surface 11A is increased. Further, with the mirror surface reflection member 45 reflecting light with specular reflection, reflected light rays are uniformly supplied to the portion of the display surface 11A close to the mirror surface reflection member 45 and the portion of the display surface 11A far away from the mirror surface reflection member 45. Therefore, difference is less likely to be caused between the amount of light rays supplied to the portion of the display surface 11A close to the mirror surface reflection member 45 and the portion of the display surface 11A far away from the mirror surface reflection member 45. Accordingly, uniformity of luminance on the display surface 11A of the electronic paper display 11 is improved.

The mirror surface reflection member 45 that is disposed on the outer side of the second edge portion 11E2 that is on an opposite side from the first edge portion 11E1 of the electronic paper display 11 is disposed directly opposite the concave mirror 43 and the reflection surface 45A is opposite the reflection surface 43A with having the space S therebetween. Therefore, some of the light rays reflected by the reflection surface 43A of the concave mirror 43 propagate along the display surface 11A and pass through the second edge portion 11E2 that is on the opposite side from the first edge portion 11E1 and are reflected by the reflection surface 45A of the mirror surface reflection member 45 (with specular reflection), which is disposed adjacent to the second edge portion 11E2. The mirror surface reflection members 45 that are disposed outside the other two second edge portions 11E2 of the electronic paper display 11 are on two end sides of the concave mirrors 43 and disposed such that the reflection surfaces 45A are opposite each other with having the space S therebetween. Therefore, some of the light rays reflected by the reflection surface 43A of the concave mirror 43 spread toward two sides in the Y-axis direction with propagating along the display surface 11A and pass through the two second edge portions 11E2, which are opposite each other, and are reflected (with specular reflection) by the two mirror surface reflection members 45 disposed adjacent to the two second edge portions 11E2. Thus, the light use efficiency is further improved and luminance of an image displayed on the display surface 11A is further increased.

Comparative Experiment 2 was performed to verify superiority of the display device 200 of this embodiment. In Comparative Experiment 2, simulations of supplying light from the front light device to the electronic paper display 11 in the display device 200 of Example 2 and display devices of Comparative 2 and Comparative Example 3 were performed with using a computer and illuminance distributions of the supplied light were obtained. In Example 2, the display device 200 of this embodiment was used. The display device of Comparative Example 2 has the configuration of Comparative Example 1 of Comparative Experiment 1 and includes the three mirror surface reflection members 45 similar to the Example 2. The display device of Comparative Example 3 includes the configuration of Example 2 and diffusion reflection members that reflect light with diffusing instead of the mirror surface reflection members 45.

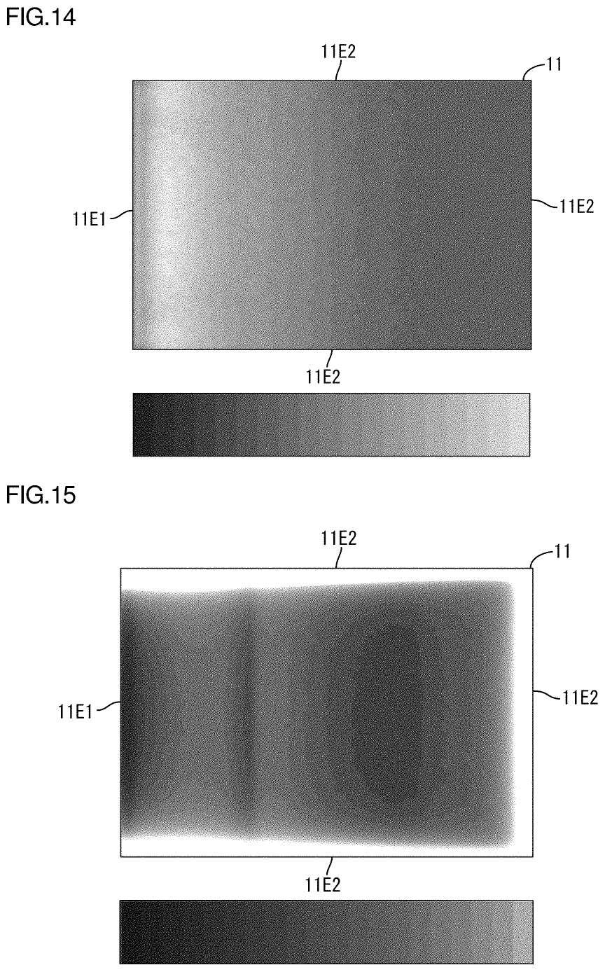

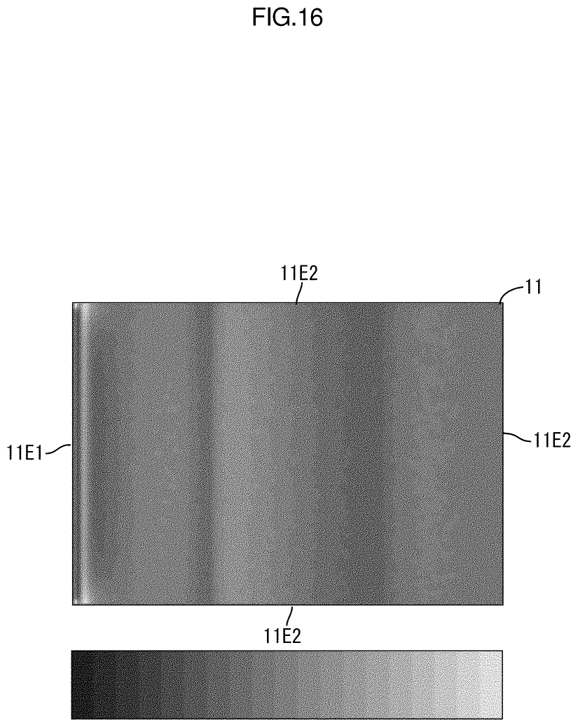

Experiment Result of Comparative Experiment 2 is illustrated in FIGS. 14 to 16. FIGS. 14 to 16 illustrate illuminance distributions within the surface area of the display surface of the electronic paper display 11 that is to be supplied with light from the front light device of the display devices of Example 2, Comparative Example 2, and Comparative Example 3. The illuminance distributions illustrated in FIGS. 14 to 16 were made similarly to the illumination distributions (FIGS. 9 and 10) described in Comparative Experiment 1. The level of illuminance is described with a degree of shading. A sample of an illuminance distribution is below the illuminance distribution in each of FIGS. 14 to 16. In FIGS. 14 to 16, the left end portion of the electronic paper display 11 corresponds to the first edge portion 11E1 that is adjacent to the front light device and other end portions of the electronic paper display 11 correspond to the second edge portions 11E2 that are adjacent to the mirror surface reflection members 45 or the diffusion reflection members. FIG. 14 illustrates an illuminance distribution of the light from the front light device of the display device of Comparative Example 2. FIG. 15 illustrates an illuminance distribution of the light from the front light device of the display device of Comparative Example 3. FIG. 16 illustrates an illuminance distribution of the light from the front light device 12 of the display device 200 of Example 2.

The Experiment result of Comparative Experiment 2 will be described. With reference to FIG. 14, the amount of light rays supplied to the display surface 11A of the electronic paper display 11 in Comparative Example 2 increases compared to the Experiment result of Comparative Example 1 illustrated in FIG. 9. However, compared to the Experiment result of Example 1 illustrated in FIG. 10, the illuminance distribution is not uniform and uniformity of luminance is low in Comparative Example 2. This may occur in Comparative Example 2 because the light use efficiency is improved due to the specular reflection by the mirror surface reflection members 45 but the amount of light rays directly supplied to the light transmissive panel 13 near the first edge portion 11E1 is quite large due to the lens 103 (refer to FIG. 6). With reference to FIG. 15, in Comparative Example 3, there is almost no difference in illuminance between the portion of the display surface 11A of the electronic paper display 11 close to the first edge portion 11E1 with respect to the X-axis direction and the portion of the display surface 11A far from the first edge portion 11E1. However, the amount of light rays is quite large in the portions of the display surface 11A of the electronic paper display 11 close to the three second edge portions 11E2. This may occur in Comparative Example 3 because the uniformity of luminance increases due to the concave mirror but the light rays are reflected with being diffused by the diffusion reflection members disposed adjacent to the second edge portions 11E2 and the reflected light rays are locally supplied to the second edge portions 11E2.

On the other hand, with reference to FIG. 16, in Example 2, uniformity of the illuminance distribution similar to that of Example 1 was obtained and the amount of light rays supplied to the display surface 11A of the electronic paper display 11 increases compared to the Experiment result of Example 1 illustrated in FIG. 10. This may occur in Example 2 because the light use efficiency is improved due to the specular reflection by the mirror surface reflection members 45. In Example 2, unlike the Experiment result of Comparative Example 3 illustrated in FIG. 15, the amount of light rays supplied to the three second edge portions 11E2 of the display surface 11A of the electronic paper display 11 is about same as the amount light rays supplied to other portions of the display surface 11A. Namely, the uniformity of the illuminance distribution is higher in Example 2 than that in Comparative Example 3 and the uniformity of luminance is effectively high in Example 2. Such effects are obtained because the light rays reflected (with specular reflection) by the mirror surface reflection members 45 that are adjacent to the second edge portions 11E2 are less likely to be locally supplied to the second edge portions 11E2 of the display surface 11A.

As previously described, this embodiment includes the mirror surface reflection members 45 that reflect light with specular reflection. The mirror surface reflection members 45 are disposed opposite the second edge portions 11E2 where the LEDs 40 and the concave mirror 43 are not disposed. Some of the light rays reflected by the reflection surface 43A of the concave mirror 43 that are not directly supplied to the display surface 11A reach the mirror surface reflection members 45 that are disposed on the lateral side of (opposite) the second edge portions 11E2 of the electronic paper display 11 and are reflected by the mirror surface reflection members 45 with specular reflection and supplied to the display surface 11A. Accordingly, light use efficiency is improved and luminance of an image displayed on the display surface 11A is increased. In the configuration including the diffusion reflection member, which reflects light with diffusing, instead of the mirror surface reflection members 45, the light rays reflected by the diffusion reflection member with diffusing are likely to be locally supplied to the second edge portions 11E2 of the display surface 11A. Compared to such a configuration, in this embodiment, the light rays reflected by the mirror surface reflection members 45 with specular reflection are less likely to be locally supplied to the second edge portions 11E2 of the display surface. Accordingly, the uniformity of luminance on the display surface 11A of the electronic paper display 11 is improved.

The electronic paper display 11 has a rectangular shape and includes one first edge portion 11E1 and three second edge portions 11E2 on the outer edge portion. The mirror surface reflection members 45 are disposed on the lateral side of (opposite) the respective three second edge portions 11E2. The mirror surface reflection member 45 that is disposed on the outer side of the second edge portion 11E2 that is on an opposite side from the first edge portion 11E1 of the electronic paper display 11 is disposed directly opposite the concave mirror 43. Therefore, some of the light rays reflected by the reflection surface 43A of the concave mirror 43 propagate along the display surface 11A and pass through the second edge portion 11E2 that is on the opposite side from the first edge portion 11E1 and are reflected by the mirror surface reflection member 45 (with specular reflection), which is disposed adjacent to the second edge portion 11E2. The mirror surface reflection members 45 that are disposed outside the other two second edge portions 11E2 of the electronic paper display 11 are on two end sides of the concave mirrors 43. Therefore, some of the light rays reflected by the reflection surface 43A of the concave mirror 43 spread toward two sides in the Y-axis direction with propagating along the display surface 11A and pass through the two second edge portions 11E2, which are opposite each other, and are reflected (with specular reflection) by the two mirror surface reflection members 45 disposed adjacent to the two second edge portions 11E2. Thus, the light use efficiency is further improved and luminance of an image displayed on the display surface 11A is further increased.

### Third Embodiment

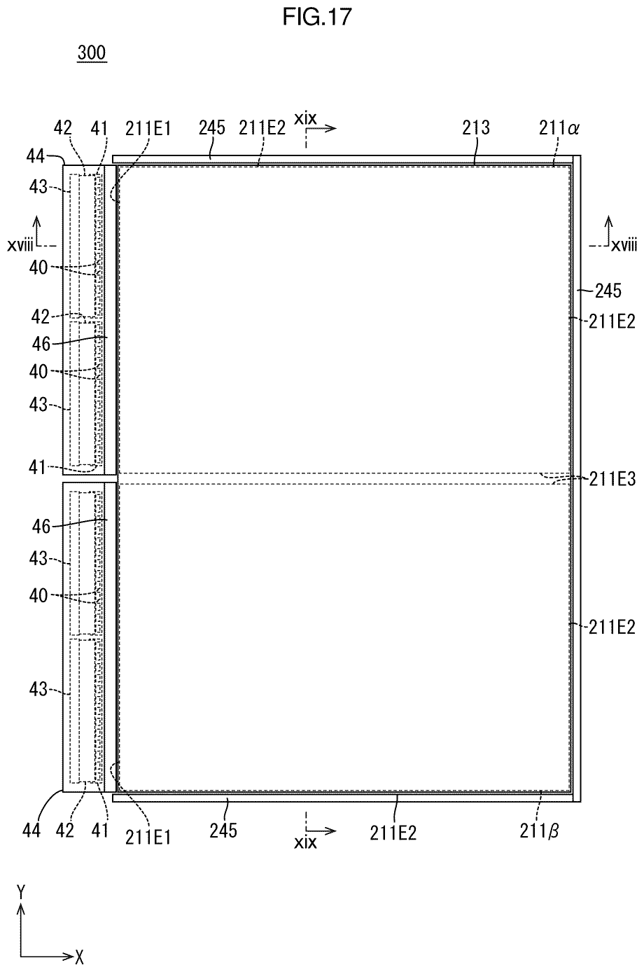

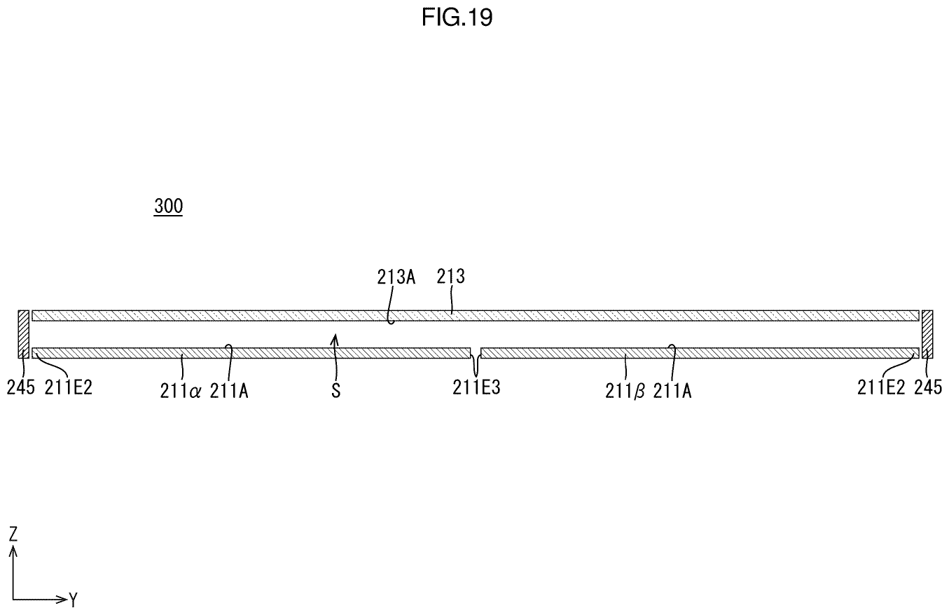

A third embodiment will be described with reference to FIGS. 17 to 23. The third embodiment basically includes the configuration of the second embodiment and further includes a louver 46 and the number of electronic paper displays differs from that of the second embodiment. The configurations, operations, and effects that are similar to those of the first and second embodiments will not be described.

As illustrated in FIG. 17, a display device 300 of this embodiment includes a first electronic paper display 211α (a first display panel), a second electronic paper display 211β (a second display panel), and two front light devices 212 including two casings 44. The first electronic paper display 211α and the second electronic paper display 211β are arranged along the Y-axis direction such that edge portions (third edge portions 211E3) of the first electronic paper display 211α and the second electronic paper display 211β extending along the X-axis direction are opposite each other. Each of the first electronic paper display 211α and the second electronic paper display 211β includes a first edge portion 211E1, two second edge portions 211E2, and a third edge portion 211E3. The LEDs 40, the LED boards 41, the reflection sheets 42, the concave mirrors 43, and the casing 44 are disposed on the lateral side of (opposite) the first edge portion 211E1. Mirror surface reflection members 245 are disposed opposite the two respective second edge portions 211E2. The LEDs 40, the LED boards 41, the reflection sheets 42, the concave mirrors 43, the casing 44, and the mirror surface reflection members 245 are not disposed opposite the third edge portion 211E3. The first edge portion 211E1 is a left edge portion of the outer edge portion of each of the first electronic paper display 211α and the second electronic paper display 211β in FIG. 17. The second edge portions 211E2 include a right edge portion of the outer edge portion of each of the first electronic paper display 211α and the second electronic paper display 211β in FIG. 17 and an opposite edge portion of the third edge portion 211E3. The third edge portions 211E3 of the first electronic paper display 211α and the second electronic paper display 211β are opposite each other. A light transmissive panel 213 has a size that covers the first electronic paper display 211α and the second electronic paper display 211β (for instance, A1 size).

As illustrated in FIG. 17, the two casings 44 are arranged along the Y-axis direction and are disposed on the lateral side of (opposite) the first edge portion 211E1 of each of the first electronic paper display 211α and the second electronic paper display 211β. Two LED boards 41, two reflection sheets 42, and two concave mirrors 43 are arranged in each of the two casings 44. Four LED boards 41 in the two casings 44 are arranged along the Y-axis direction and the LEDs 40 on the LED boards 41 are arranged in a row. The four reflection sheets 42 and the four concave mirrors 43 in the two casings 44 are arranged along the Y-axis direction.

The first electronic paper display 211α is disposed on an upper side in FIG. 17 and the second electronic paper display 211β is disposed on a lower side in FIG. 17.

As illustrated in FIG. 17, the first electronic paper display 211α and the second electronic paper display 211β are disposed such that the third edge portions 211E3 are opposite each other with having a small space therebetween or are contacted with each other. One of the mirror surface members 245 is disposed on the lateral side of (opposite) the second edge portion 211E2 of the first electronic paper display 211α that extends along the X-axis direction. Another one of the mirror surface members 245 is disposed on the lateral side of (opposite) the second edge portion 211E2 of the second electronic paper display 211β that extends along the X-axis direction. Other one of the mirror surface reflection members 245 is disposed on the lateral side of (opposite) the second edge portions 211E2 of the first electronic paper display 211α and the second electronic paper display 211β that extend along the Y-axis direction. The mirror surface reflection member 245 extending along the Y-axis direction has a length that extends from the first electronic paper display 211α to the second electronic paper display 211β. Namely, the mirror surface reflection member 245 extending along the Y-axis direction has at least a length of the total of the Y-axis dimensions of the first electronic paper display 211α and the second electronic paper display 211β.

In this embodiment, an image is displayed on display surfaces 211A of the first electronic paper display 211α and the second electronic paper display 211β that are disposed such that the third edge portions 211E3 are arranged next to each other. Therefore, a screen size of the display surface is about twice as that of the second embodiment. Specifically, in this embodiment, a long side dimension and a short side dimension of a display area AA are about 836 mm and 592 mm, respectively. Furthermore, the mirror surface reflection members 245 are disposed on the lateral side of (opposite) the respective two second edge portions 211E2 of each of the first electronic paper display 211α and the second electronic paper display 211β. Therefore, light use efficiency is improved.

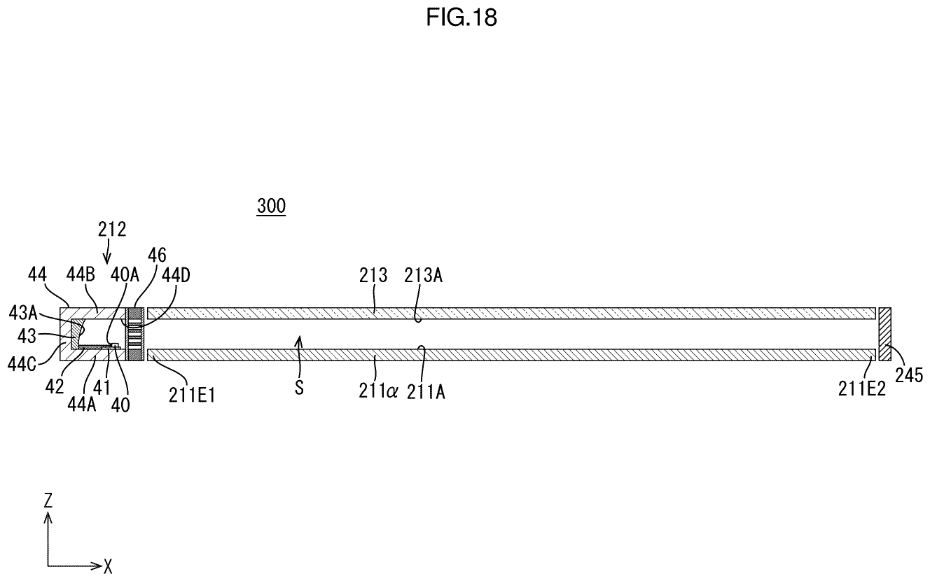

As illustrated in FIGS. 17 and 18, the front light devices 212 of this embodiment include the louvers 46 that are disposed between the casings 44 and the first electronic paper display 211α and the second electronic paper display 211β, respectively. The louver 46 is disposed on the lateral side of (opposite) the first edge portion 211E1 of each of the first electronic paper display 211α and the second electronic paper display 211β and is closer to the first edge portion 211E1 than the casing 44 is. The louver 46 is for regulating a light exit angle range of light rays that exit through the opening 44D of the casing 44. The louver 46 is a sheet member elongated along the Y-axis direction. The louvers 46 are disposed such that surfaces of the louvers 46 are about vertical to the display surfaces 211A of the first electronic paper display 211α and the second electronic paper display 211β, respectively, and are opposite the reflection surfaces 43A of the concave mirrors 43. Two louvers 46 are disposed opposite the respective first edge portions 211E1 of the first electronic paper display 211α and the second electronic paper display 211β. The two louvers 46 are arranged along the Y-axis direction. The louver 46 has a length that extends along at least an entire length of the casing 44. The louver 46 has a width (measured in the Z-axis direction) that is greater than the thickness (an opening width of the opening 44D measured in the Z-axis direction) of the space S between the light transmissive panel 213 and each of the first electronic paper display 211α and the second electronic paper display 211β. As illustrated in FIGS. 17 to 19, the mirror surface reflection members 245, which have a configuration similar to that of the second embodiment, are disposed on the lateral side of (opposite) the second edge portions 211E2 of the first electronic paper display 211α and the second electronic paper display 211β.

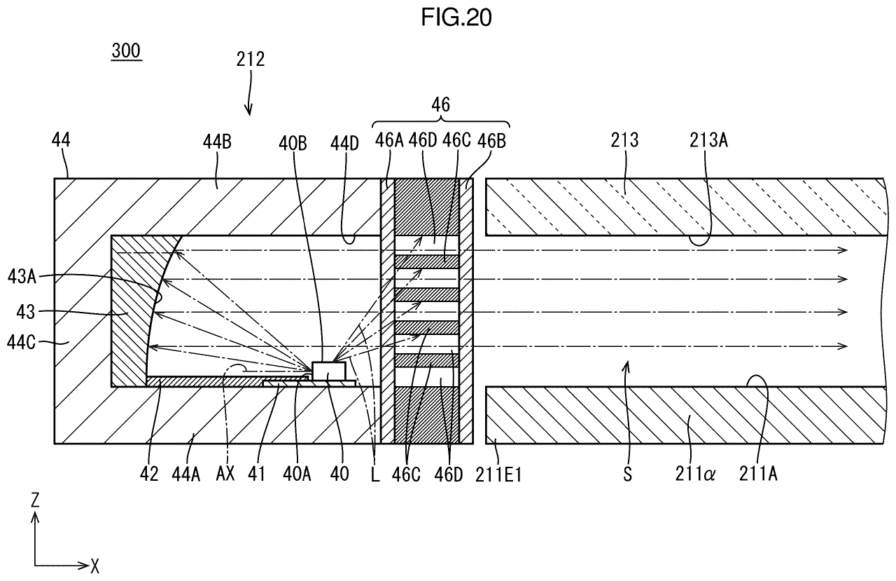

As illustrated in FIG. 20, the louver 46 includes a first base member 46A, a second base member 46B, light blocking portions 46C that are disposed between the first and second base members 46A, 46B, and a light transmissive portions 46D that are disposed between the first and second base members 46A, 46B. The first base member 46A is close to the casing 44 (on a left side in FIG. 20) and the second base member 46B is closer to the electronic paper display (on a right side in FIG. 20). The first base member 46A and the second base member 46B are made of synthetic resin that is substantially transparent and have good light transmissive properties.

As illustrated in FIG. 20, the light blocking portions 46C are made of light blocking resin material (light blocking material) that exhibits black and blocks light. The light blocking portions 46C are disposed in layers extending along the X-axis direction and the Y-axis direction and are arranged at intervals in the Z-axis direction (a normal direction to the display surface 211A). The light transmissive portions 46D are made of light transmissive resin material (light transmissive material) that is substantially transparent and transmits light. The light transmissive portions 46D may be air layers. The light transmissive portions 46D are disposed in layers extending along the X-axis direction and the Y-axis direction and are arranged at intervals in the Z-axis direction. The light transmissive portions 46D are disposed in an area with respect to the Z-axis direction that corresponds to the opening 44D and the space S. The light transmissive portions 46D are opposite the opening 44D and the space S. Accordingly, the light rays exiting through the opening 44D enter the light transmissive portions 46D and travel through and exit the light transmissive portions 46D toward the space S. The light blocking portions 46C and the light transmissive portions 46D are disposed alternately in the Z-axis direction. Therefore, the light transmissive portion 46D is between the two light blocking portions 46C that are adjacent to each other at an interval in the Z-axis direction and the light blocking portion 46C is between the two light transmissive portions 46D that are adjacent to each other at an interval in the Z-axis direction. The light rays that exit through the opening 44D of the casing 44 and pass through the first base member 46A pass through the light transmissive portion 46D that is between the two adjacent light blocking portions 46C in the Z-axis direction and further pass through the second base member 46B. The angle of refraction of the light rays exiting the second base member 46B with respect to the Z-axis is regulated by the two light blocking portions 46C that are adjacent to each other in the Z-axis direction.

As illustrated in FIG. 20, the LED 40 included in the front light device 212 is a so-called side surface emitting LED and is configured such that all the light rays exit through the light emitting surface 40A that is opposite the concave mirror 43. However, some of the light rays may leak through a top surface 40B that is opposite the second casing body portion 44B. Such light rays L leaking through the top surface 40B do not propagate toward the concave mirror 43 but may be directly supplied to the light transmissive panel 213. Such light rays L propagate in an oblique direction with an angle greater than a predefined angle with respect to the optical axis AX (the X-axis direction) of the LED 40 and do not propagate along the display surface 211A. Therefore, most of the light rays L leaking through the top surface 40B of the LED 40 do not pass through the light transmissive portions 46D of the louver 46 but are absorbed by the light blocking portions 46C. Accordingly, the light rays emitted by the LED 40 is less likely to be directly supplied to the light transmissive panel 213. Therefore, uniformity of luminance within the display surface 211A of each of the first electronic paper display 211α and the second electronic paper display 211β is further improved.

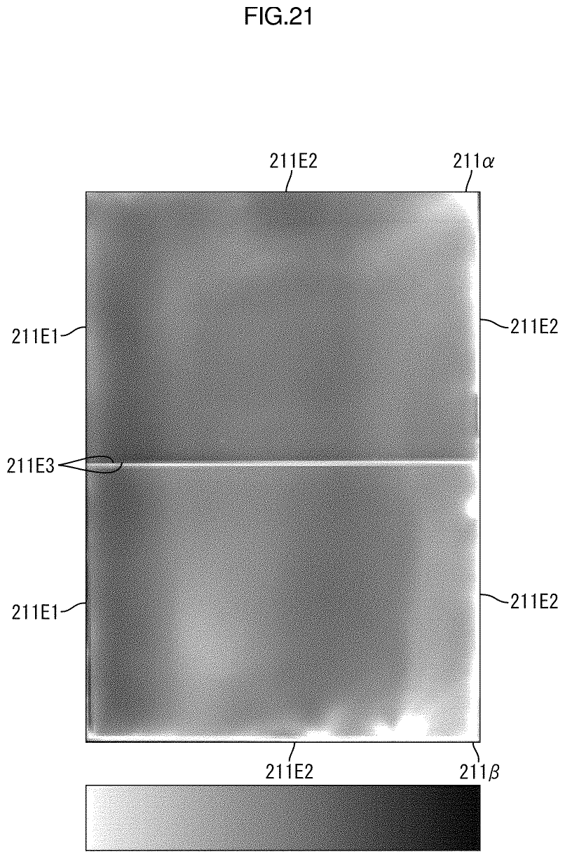

Verifying Experiment 1 was performed to verify superiority of the front light device 212 of this embodiment. In Verifying Experiment 1, light from the front light device 212 of Example 3 is supplied to each of the first electronic paper display 211α and the second electronic paper display 211β and an illuminance distribution of the supplied light was obtained. In Example 3, the front light device 212 was used. Experiment results of Verifying Experiment 1 are illustrated in FIGS. 21 to 23. FIG. 21 illustrates a luminance distribution within surface areas of the display surfaces 211A of the first electronic paper display 211α and the second electronic paper display 211β that are objects to be supplied with light rays from the front light devices 212 of Example 3. The illuminance distribution illustrated in FIG. 21 was obtained by supplying light to the display surfaces 211A of the first electronic paper display 211α and the second electronic paper display 211β with all the LEDs 40 of the front light devices 212 being ON and measuring the luminance of the light exiting through the display surfaces 211A. The level of luminance is described with a degree of shading. A sample of a luminance distribution is below the luminance distribution in FIG. 21. In the sample, the shading becomes brighter (closer to white) as the luminance becomes higher and the shading becomes darker (closer to black) as the luminance becomes lower. In FIG. 21, the left end portions of the first electronic paper display 211α and the second electronic paper display 211β correspond to the first edge portions 211E1 that are adjacent to the front light devices 212. The luminance distribution of the first electronic paper display 211α is illustrated in an upper section in FIG. 21 and the luminance distribution of the second electronic paper display 211β is illustrated in a lower section in FIG. 21.

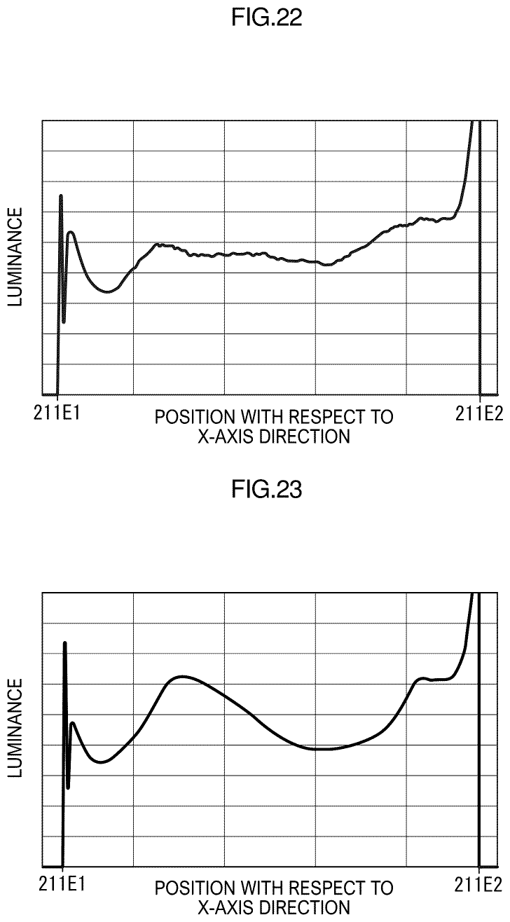

FIG. 22 illustrates a graph related to the luminance distribution of the first electronic paper display 211α with respect to the X-axis direction. FIG. 23 is a graph related to the luminance distribution of the second electronic paper display 211β with respect to the X-axis direction. Each of the graphs in FIGS. 22 and 23 illustrates the luminance distribution with respect to the X-axis direction in a middle section of each of the first electronic paper display 211α and the second electronic paper display 211β with respect to the Y-axis direction. The vertical axis in FIGS. 22 and 23 represents luminance. The horizontal axis in FIGS. 22 and 23 represents positions with respect to the X-axis direction. The left end position of the horizontal axis matches the first edge portion 211E1 of the first electronic paper display 211α and the second electronic paper display 211β. The right end position of the horizontal axis matches the second edge portion 211E2 of the first electronic paper display 211α and the second electronic paper display 211β that is an opposite edge portion from the first edge portion 211E1.

Experiment results of Verifying Experiment 1 will be described. With reference to FIGS. 21 to 23, there is almost no difference in illuminance between the portions of the display surfaces 211A of the first electronic paper display 211α and the second electronic paper display 211β close to the first edge portion 211E1 and the portions of the display surfaces 211A far from the first edge portion 211E1 with respect to the X-axis direction. Particularly, any portion having locally high luminance is less likely to be included in the portions of the display surfaces 211A of the first electronic paper display 211α and the second electronic paper display 211β close to the first edge portion 211E1 with respect to the X-axis direction. This is caused because the light lays L exiting through the top surfaces 40B of the LEDs 40 are effectively blocked by the light blocking portions 46C of the louver 46. There is no large difference between the luminance distribution of the first electronic paper display 211α and the luminance distribution of the second electronic paper display 211β. Thus, in Example 3, unevenness is less likely to be in the luminance distribution and uniformity of the luminance is effectively high.

As previously described, this embodiment includes the louvers 46 that are disposed on a lateral side with respect to the first electronic paper display 211α and the second electronic paper display 211β (the light supplied object) and opposite the reflection surfaces 43A. The louver 46 includes two light blocking portions 46C that are spaced from each other in a normal direction to the display surface 211A (the light supplied surface) and the light transmissive portion 46D that is disposed between the two light blocking portions 46C. With the light rays reflecting off the reflection surfaces 43A and reaching the louvers 46 that are disposed opposite the reflection surfaces 43A and on the lateral side with respect to the first electronic paper display 211α and the second electronic paper display 211β (the light supplied object), the light rays pass through the light transmissive portion 46D that is between the two light blocking portions 46C and are supplied to the display surface 211A (the light supplied surface) of the first electronic paper display 211α and the second electronic paper display 211β (the light supplied object). If the reflected light rays reflecting off the reflection surface 43A may include light rays (light rays L leaking through the top surface 40B) that do not propagate along the display surface 211A (the light supplied surface), such light rays are blocked by the light blocking portions 46C. Accordingly, uniformity of luminance within the display surfaces 211A (the light supplied surface) of the first electronic paper display 211α and the second electronic paper display 211βt (the object to be supplied with light) is further improved.

Each of the first electronic paper display 211α and the second electronic paper display 211β has a rectangular shape and includes the third edge portion 211E3, the first edge portion 211E1, and the two second edge portions 211E2 on the outer edge portion. The LEDs 40, the concave mirror 43, and the mirror surface reflection member 245 are not disposed opposite the third edge portion 211E3. The first electronic paper display 211α (the first display panel) and the second electronic paper display 211β (the second display panel) are disposed such that the third edge portions 211E3 are arranged next to (opposite) each other. The mirror surface reflection members 245 are disposed on the lateral side of (opposite) the two second edge portions 211E2 of each of the first electronic paper display 211α and the second electronic paper display 211β. With an image being displayed on the display surfaces 211A of the first electronic paper display 211α and the second electronic paper display 211β, which are arranged such that the third edge portions 211E3 are arranged next to each other, a screen size is increased. Furthermore, with the mirror surface reflection members 245 being disposed on the lateral side of the two second edge portions 211E2 of each of the first electronic paper display 211α and the second electronic paper display 211β, the light use efficiency is improved.

### Fourth Embodiment

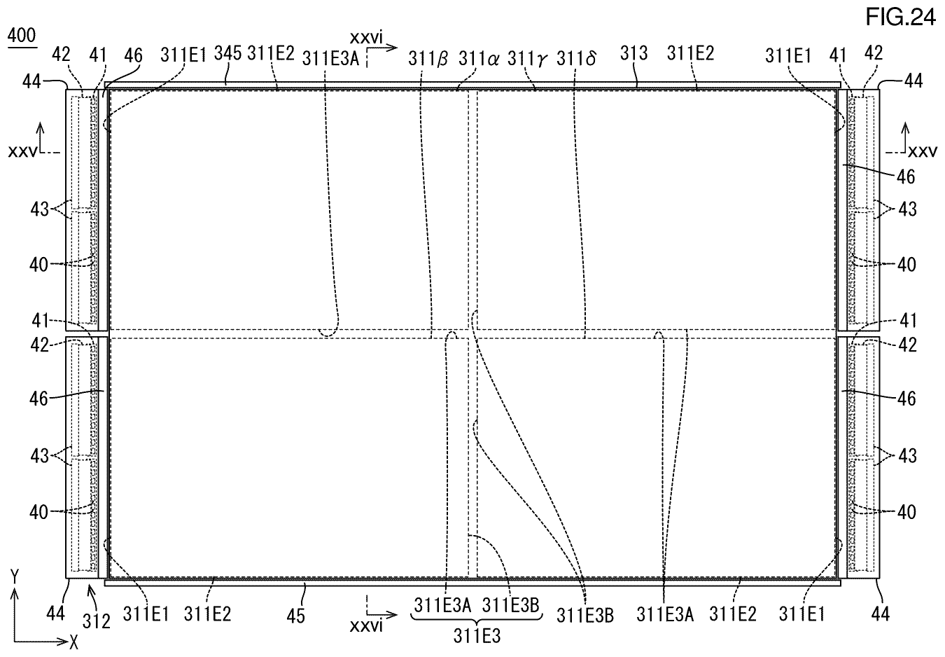

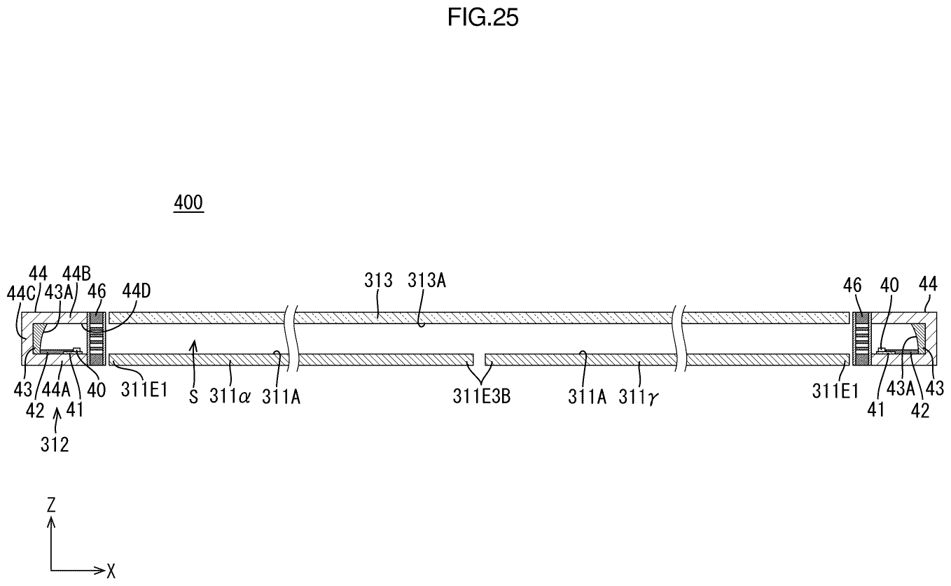

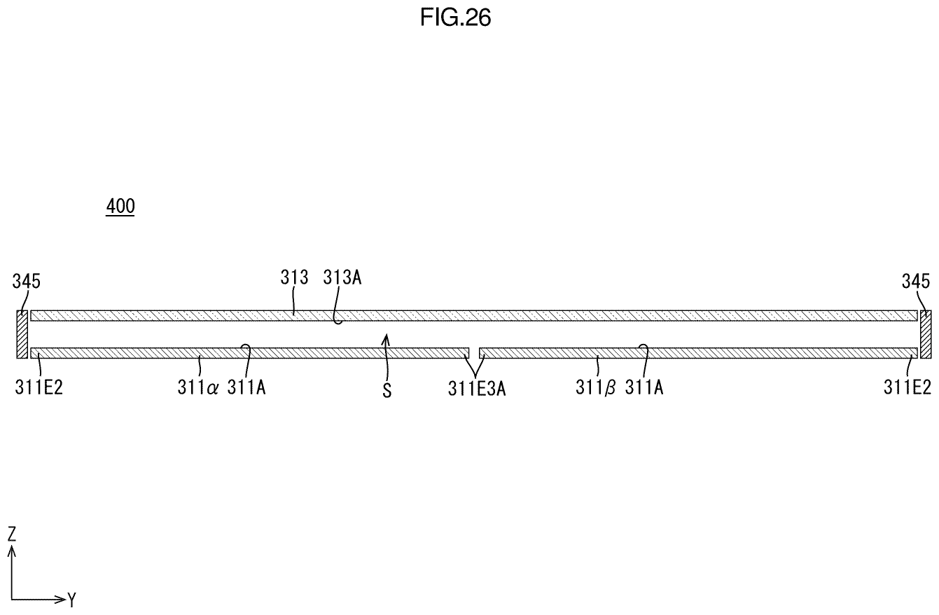

A fourth embodiment will be described with reference to FIGS. 24 to 26. The fourth embodiment basically includes the configuration of the third embodiment and the number of electronic paper displays differs from that of the third embodiment. The configurations, operations, and effects that are similar to those of the third embodiment will not be described.

As illustrated in FIG. 24, a display device 400 of this embodiment includes four electronic paper displays and four front light devices 312 including four casings 44 and four louvers 46. The four electronic paper displays include a first electronic paper display 311α, a second electronic paper display 311β, a third electronic paper display 311γ, and a fourth electronic paper display 311δ. The first electronic paper display 311α, the second electronic paper display 311β, the third electronic paper display 311γ, and the fourth electronic paper display 311δ are arranged in a grid such that edge portions extending along the X-axis direction (third edge portions 311E3A) are opposite each other and edge portions extending along the Y-axis direction (third edge portions 311E3B) are opposite each other. Each of the first electronic paper display 311α, the second electronic paper display 311β, the third electronic paper display 311γ, and the fourth electronic paper display 311δ includes a first edge portion 311E1, a second edge portion 311E2, and two third edge portions 311E3. The LEDs 40, the LED boards 41, the reflection sheets 42, the concave mirrors 43, and the casing 44 are disposed opposite the first edge portion 311E1. A mirror surface reflection member 345 is disposed opposite the second edge portion 311E2. The LEDs 40, the LED boards 41, the reflection sheets 42, the concave mirrors 43, the casing 44, and the mirror surface reflection member 345 are not disposed opposite the third edge portions 311E3. The first edge portion 311E1 is on the opposite side from the third edge portion 311E3B (other third edge portion). The second edge portion 311E2 is on the opposite side from the third edge portion 311E3A (one third edge portion). The two third edge portions 3 11E3 of one of the four electronic paper displays 311α, 311β, 311γ, 311δ are opposite the third edge portions 311E3 of other electronic paper displays. The two third edge portions 311E3 include the third edge portion 311E3A extending along the X-axis direction and the third edge portion 311E3B extending along the Y-axis direction. A light transmissive panel 313 has a size that covers the four electronic paper displays 311α, 311β, 311γ, 311δ (for instance A0 size).

In this embodiment, the first electronic paper display 311α (the first display panel) is disposed on the upper left side in FIG. 24, the second electronic paper display 311β (the second display panel) is disposed on the lower left side in FIG. 24, the third electronic paper display 311γ (a third display panel) is disposed on the upper right side in FIG. 24, and the fourth electronic paper display 311δ (a fourth display panel) is disposed on the lower right side in FIG. 24.

As illustrated in FIG. 24, the four casings 44 and the four louvers 46 are disposed on the lateral side (opposite) the first edge portions 311E1 of the first electronic paper display 311α, the second electronic paper display 311β, the third electronic paper display 311γ, and the fourth electronic paper display 311δ, respectively. Two LED boards 41, two reflection sheets 42, and two concave mirrors 43 are arranged in each of the four casings 44. Four LED boards 41 in the two casings 44 that are disposed on the lateral side of (opposite) the first edge portions 311E1 of the first electronic paper display 311α and the second electronic paper display 311β, respectively, are arranged along the Y-axis direction and the LEDs 40 on the four LED boards 41 are arranged in a row. Similarly, four LED boards 41 in the two casings 44 that are disposed on the lateral side of (opposite) the third electronic paper display 311γ and the fourth electronic paper display 311δ, respectively, are arranged along the Y-axis direction and the LEDs 40 on the four LED boards 41 are arranged in a row. The four louvers 46 are disposed between the four casings 44 and the first edge portions 311E1 of the four electronic paper displays 311α, 311β, 311γ, 311δ, respectively.

As illustrated in FIGS. 24 to 26, the first electronic paper display 311α, the second electronic paper display 311β, the third electronic paper display 311γ, and the fourth electronic paper display 311δ are disposed such that the third edge portions 311E3 are spaced away from each other or contacted with each other. As illustrated in FIGS. 24 to 26, one of the mirror surface reflection members 345 is disposed on the lateral side of (opposite) the second edge portions 311E2 of the first electronic paper display 311α and the third electronic paper display 311γ. Another one of the mirror surface reflection members 345 is disposed on the lateral side of (opposite) the second edge portions 311E2 of the second electronic paper display 311β and the fourth electronic paper display 311δ. The mirror surface reflection member 345 disposed on the lateral side of (opposite) the second edge portions 311E2 of the first electronic paper display 311α and the third electronic paper display 311γ has a length dimension extending from (the first edge portion 311E1 of) the first electronic paper display 311α to (the first edge portion 311E1 of) the third electronic paper display 311γ. The mirror surface reflection members 345 disposed on the lateral side of (opposite) the second edge portions 311E2 of the second electronic paper display 311β and the fourth electronic paper display 311δ has a length dimension extending from (the first edge portion 311E1 of) the second electronic paper display 311β to (the first edge portion 311E1 of) the fourth electronic paper display 311δ.

In this embodiment, with an image being displayed on display surfaces 311A of the first electronic paper display 311α, the second electronic paper display 311β, the third electronic paper display 311γ, and the fourth electronic paper display 311δ, which are arranged such that the third edge portions 3 11E3 are arranged next to each other, a screen size is increased and is about twice as that of the third embodiment. Specifically, a long side dimension and a short side dimension of a display area AA are about 1,184 mm and 836 mm, respectively. Furthermore, with the mirror surface reflection members 345 being disposed on the lateral side of the second edge portions 311E2 of the first electronic paper display 311α, the second electronic paper display 311β, the third electronic paper display 311γ, and the fourth electronic paper display 311δ, the light use efficiency is improved.

As previously described, this embodiment includes the first electronic paper display 311α (the first display panel), the second electronic paper display 311β (the second display panel), the third electronic paper display 311γ (the third display panel), and the fourth electronic paper display 311δ (the fourth display panel). In this embodiment, the electronic paper display 311α, 311β, 311γ, 311δ has a rectangular shape and includes an outer peripheral edge portion including the two third edge portions 311E3, the first edge portion 311E1, and the second edge portion 311E2. The LEDs 40, the concave mirrors 43, and the mirror surface reflection members 345 are not disposed opposite the third edge portions 311E3. The first electronic paper display 311α and the second electronic paper display 311β are disposed such that the third edge portions 311E3A (one third edge portion) of the first electronic paper display 311α and the second electronic paper display 311β are arranged next to each other. The third electronic paper display 311γ and the fourth electronic paper display 311δ are disposed such that the third edge portions 311E3A of the third electronic paper display 311γ and the fourth electronic paper display 311δ are arranged next to each other.

The first electronic paper display 311α and the third electronic paper display 311γ are disposed such that the third edge portions 311E3B (other third edge portion) of the first electronic paper display 311α and the third electronic paper display 311γ are arranged next to each other. The second electronic paper display 311β and the fourth electronic paper display 311δ are arranged such that the third edge portions 311E3B of the second electronic paper display 311β and the fourth electronic paper display 311δ are arranged next to each other. The mirror surface reflection members 345 are disposed opposite the second edge portions 311E2 of the first electronic paper display 311α, the second electronic paper display 311β, the third electronic paper display 311γ, and the fourth electronic paper display 311δ. With an image being displayed on the display surfaces 311A of the first electronic paper display 311α, the second electronic paper display 311β, the third electronic paper display 311γ, and the fourth electronic paper display 311δ, which are arranged such that the third edge portions 311E3 are arranged next to each other, a screen size is increased. Furthermore, the mirror surface reflection members 345 are disposed opposite the second edge portions 311E2 of the first electronic paper display 311α, the second electronic paper display 311β, the third electronic paper display 311γ, and the fourth electronic paper display 311δ. Therefore, light use efficiency is improved.

### Fifth Embodiment

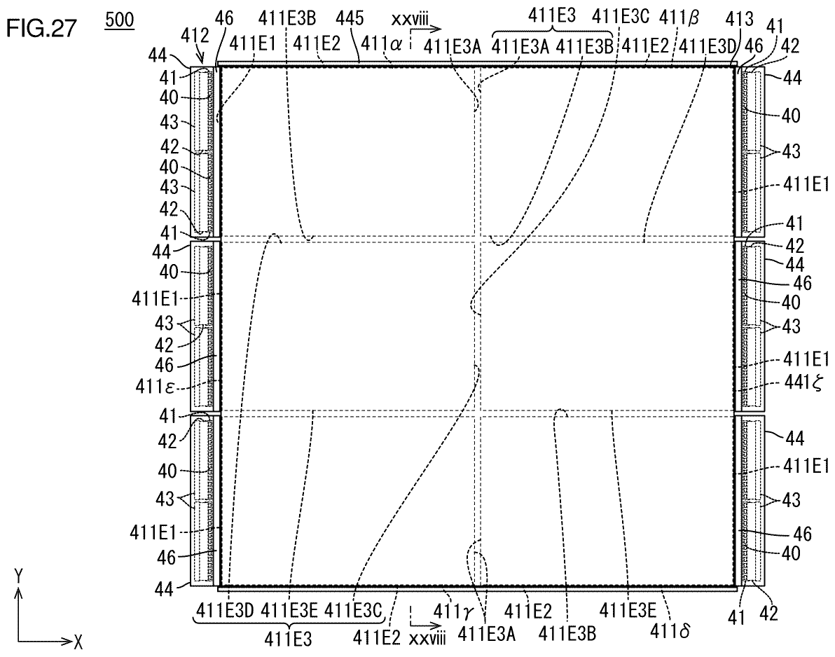

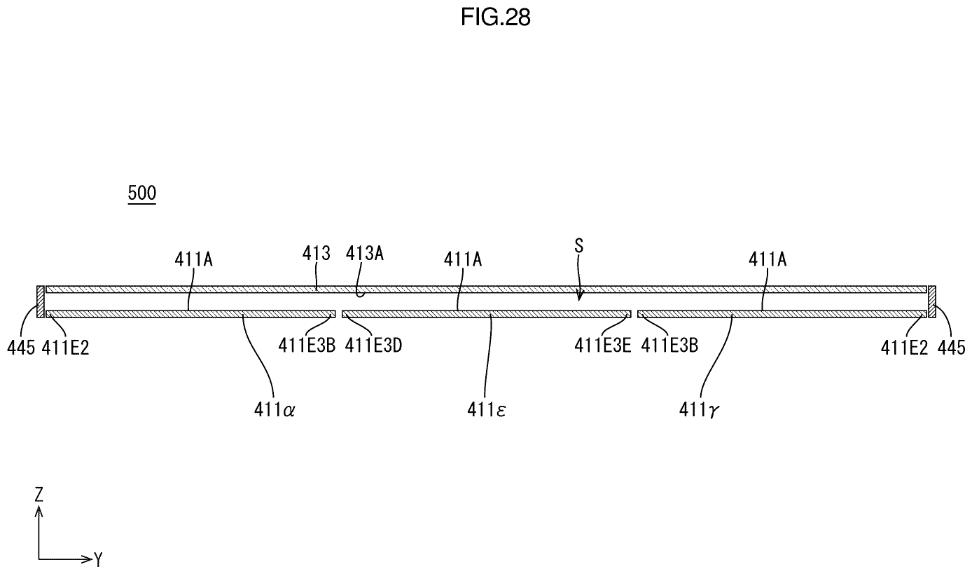

A fifth embodiment will be described with reference to FIGS. 27 and 28. The fifth embodiment basically includes the configuration of the third embodiment and the number of electronic paper displays differs from that of the third embodiment. The configurations, operations, and effects that are similar to those of the third embodiment will not be described.

As illustrated in FIG. 27, a display device 500 of this embodiment includes six electronic paper displays and six front light devices 412 including six casings 44 and six louvers 46. Among the six electronic paper displays, two columns of electronic paper displays are arranged along the X-axis direction and three rows of electronic paper displays are arranged along the Y-axis direction. The edge portions of the electronic paper displays extending along the X-axis direction are opposite each other and the edge portions extending along the Y-axis direction are opposite each other. The six electronic paper displays include a first electronic paper display 411α (the first display panel), a second electronic paper display 411β (the second display panel), a third electronic paper display 411γ (the third display panel), a fourth electronic paper display 411δ (the fourth display panel), a fifth electronic paper display 411ϵ (a fifth display panel), and a sixth electronic paper display 411ζ (a sixth display panel). A light transmissive panel 413 has a size that covers the six electronic paper displays 411α, 411β, 411γ, 411δ, 411ϵ, 411ζ.

In this embodiment, the first electronic paper display 411α is disposed on the upper left side in FIG. 27, the second electronic paper display 411β is disposed on the upper right side in FIG. 27, the third electronic paper display 411γ is disposed on the lower left side in FIG. 27, the fourth electronic paper display 411δ is disposed on the lower right side in FIG. 27, the fifth electronic paper display 411ϵ is disposed in the left middle in FIG. 27, and the sixth electronic paper display 411ζ is in the right middle in FIG. 27.

The first electronic paper display 411α, the second electronic paper display 411β, the third electronic paper display 411γ, and the fourth electronic paper display 411δ include outer edge portions, respectively. As illustrated in FIG. 27, the outer edge portion includes a first edge portion 411E1, a second edge portion 411E2, and two third edge portions 411E3. The LEDs 40, the LED boards 41, the reflection sheets 42, the concave mirrors 43, and the casing 44 are disposed on a lateral side of (opposite) the first edge portion 411E1. A mirror surface reflection member 445 is disposed on the lateral side of (opposite) the second edge portion 411E2. The LEDs 40, the LED boards 41, the reflection sheets 42, the concave mirrors 43, the casing 44, and the mirror surface reflection member 445 are not disposed opposite the third edge portions 411E3. The first edge portion 411E1 of the first electronic paper display 411α, the second electronic paper display 411β, the third electronic paper display 411γ, and the fourth electronic paper display 411δ is on the opposite side from a third edge portion 411E3A (one third edge portion) of the two third edge portions 411E3 of the outer edge portion of the electronic paper display. The second edge portion 411E2 of the first electronic paper display 411α, the second electronic paper display 411β, the third electronic paper display 411γ, and the fourth electronic paper display 411δ is on the opposite side from a third edge portion 411E3B (other third edge portion) of the two third edge portions 411E3 of the outer edge portion of the electronic paper display. The two third edge portions 411E3 of each of the first electronic paper display 411α, the second electronic paper display 411β, the third electronic paper display 411γ, and the fourth electronic paper display 411δ include the third edge portion 411E3A extending along the Y-axis direction and the third edge portion 411E3B extending along the X-axis direction.

The fifth electronic paper display 411ϵ and the sixth electronic paper display 411ζ include outer edge portions, respectively. As illustrated in FIG. 27, the outer edge portion of each of the fifth electronic paper display 411ϵ and the sixth electronic paper display 411ζ includes the first edge portion 411E1 and three third edge portions 411E3. The LEDs 40, the LED boards 41, the reflection sheets 42, the concave mirrors 43, and the casing 44 are disposed on the lateral side of (opposite) the first edge portion 411E1. The LEDs 40, the LED boards 41, the reflection sheets 42, the concave mirrors 43, the casing 44, and the mirror surface reflection member 445 are not disposed opposite the third edge portions 411E3. The first edge portion 411E1 of the fifth electronic paper display 411ϵ and the sixth electronic paper display 411ζ is on the opposite side from a third edge portion 411E3C (one third edge portion) of the three third edge portions 411E3 of the outer edge portion of the electronic paper display. The three third edge portions 411E3 of each of the fifth electronic paper display 411ϵ and the sixth electronic paper display 411ζ include the third edge portion 411E3C extending along the Y-axis direction (one third edge portion), a third edge portion 411E3D (a first opposed third edge portion) and a third edge portion 411E3E (a second opposed third edge portion) extending along the X-axis direction.

As illustrated in FIG. 27, the six casings 44 and the six louvers 46 are disposed on the lateral side (opposite) the first edge portions 411E1 of the six electronic paper displays 411α, 411β, 411γ, 411δ, 411ϵ, 411ζ, respectively. Two LED boards 41, two reflection sheets 42, and two concave mirrors 43 are arranged in each of the six casings 44. The six LED boards 41 in the three casings 44 that are disposed on the lateral side of (opposite) the first edge portions 411E1 of the first electronic paper display 411α, the third electronic paper display 411γ, and the fifth electronic paper display 411ϵ, respectively, are arranged along the Y-axis direction and the LEDs 40 on the six LED boards 41 are arranged in a row. Similarly, the six LED boards 41 in the three casings 44 that are disposed on the lateral side of (opposite) the first edge portions 411E1 of the second electronic paper display 411β, the fourth electronic paper display 411δ, and the sixth electronic paper display 411ζ, respectively, are arranged along the Y-axis direction and the LEDs 40 on the six LED boards 41 are arranged in a row. The six louvers 46 are disposed between the six casings 44 and the first edge portions 411E1 of the six electronic paper displays 411α, 411β, 411γ, 411δ, 411ϵ, 411ζ, respectively.

As illustrated in FIG. 27, the first electronic paper display 411α, the second electronic paper display 411β, the third electronic paper display 411γ, the fourth electronic paper display 411δ, the fifth electronic paper display 411ϵ, and the sixth electronic paper display 411ζ are disposed such that the third edge portions 411E3 are spaced away from each other or contacted with each other. Specifically, the first electronic paper display 411α and the second electronic paper display 411β are disposed such that the third edge portions 411E3A thereof extending along the Y-axis direction are opposite each other. The third electronic paper display 411γ and the fourth electronic paper display 411δ are disposed such that the third edge portions 411E3A thereof extending along the Y-axis direction are opposite each other. The fifth electronic paper display 411ϵ and the sixth electronic paper display 411ζ are disposed such that the third edge portions 411E3C thereof extending along the Y-axis direction are opposite each other and are configured as one pair. This embodiment includes a pair of the fifth electronic paper display 411ϵ and the sixth electronic paper display 411ζ. However, two or more pairs of the fifth electronic paper display 411ϵ and the sixth electronic paper display 411ζ may be included. A pair of the fifth electronic paper display 411ϵ and the sixth electronic paper display 411ζ is disposed between the first electronic paper display 411α and the third electronic paper display 411γ with respect to the Y-axis direction and is disposed also between the second electronic paper display 411β and the fourth electronic paper display 411δ with respect to the Y-axis direction. The third edge portion 411E3B of the first electronic paper display 411α extending along the X-axis direction is opposite the third edge portion 411E3D of the fifth electronic paper display 411ϵ extending along the X-axis direction. The third edge portion 411E3B of the third electronic paper display 411γ extending along the X-axis direction is opposite the third edge portion 411E3E of the fifth electronic paper display 411ϵ extending along the X-axis direction. The third edge portion 411E3B of the second electronic paper display 411β extending along the X-axis direction is opposite the third edge portion 411E3D of the sixth electronic paper display 411ζ extending along the X-axis direction. The third edge portion 411E3B of the fourth electronic paper display 411δ extending along the X-axis direction is opposite the third edge portion 411E3E of the sixth electronic paper display 411ζ extending along the X-axis direction.

As illustrated in FIGS. 27 and 28, one of the mirror surface reflection members 445 is disposed on the lateral side of (opposite) the second edge portions 411E2 of the first electronic paper display 411α and the second electronic paper display 411β. Another one of the mirror surface reflection members 445 is disposed on the lateral side of (opposite) the second edge portions 411E2 of the third electronic paper display 411γ and the fourth electronic paper display 411δ. The mirror surface reflection member 445 disposed on the lateral side of (opposite) the second edge portions 411E2 of the first electronic paper display 411α and the second electronic paper display 411β has a length dimension extending from (the first edge portion 411E1 of) the first electronic paper display 411α to (the first edge portion 411E1 of) the second electronic paper display 411β. The mirror surface reflection members 445 disposed on the lateral side of (opposite) the second edge portions 411E2 of the third electronic paper display 411γ and the fourth electronic paper display 411δ has a length dimension extending from (the first edge portion 411E1 of) the third electronic paper display 411γ to (the first edge portion 411E1 of) the fourth electronic paper display 411δ.

In this embodiment, with an image being displayed on display surfaces 411A of the first electronic paper display 411α, the second electronic paper display 411β, the third electronic paper display 411γ, the fourth electronic paper display 411δ, the fifth electronic paper display 411ϵ, and the sixth electronic paper display 411ζ, which are arranged such that the third edge portions 411E3 are arranged next to each other, a screen size is increased and is about three times as that of the third embodiment (1.5 times as that of the fourth embodiment). Specifically, one side dimension of a display area AA is about 1,184 mm and another side dimension of the display area AA is about 1,254 mm. Furthermore, with the mirror surface reflection members 445 being disposed on the lateral side of the second edge portions 411E2 of the first electronic paper display 411α, the second electronic paper display 411β, the third electronic paper display 411γ, and the fourth electronic paper display 411δ, the light use efficiency is improved.

As previously described, this embodiment includes the first electronic paper display 411α (the first display panel), the second electronic paper display 411β (the second display panel), the third electronic paper display 411γ (the third display panel), the fourth electronic paper display 411δ (the fourth display panel), the fifth electronic paper display 411ϵ (the fifth display panel), and the sixth electronic paper display 411ζ (the sixth display panel). In this embodiment, each of the first electronic paper display 411α, the second electronic paper display 411β, the third electronic paper display 411γ, and the fourth electronic paper display 411δ has a rectangular shape and includes an outer peripheral edge portion including the two third edge portions 411E3, the first edge portion 411E1, and the second edge portion 411E2. The LEDs 40, the concave mirrors 43, and the mirror surface reflection members 445 are not disposed opposite the two third edge portions 411E3. Each of the fifth electronic paper display 411ϵ and the sixth electronic paper display 411ζ has a rectangular shape and includes an outer peripheral edge portion including the three third edge portions 411E3 and the first edge portion 411E1. The LEDs 40, the concave mirrors 43, and the mirror surface reflection members 445 are not disposed opposite the three third edge portions 411E3. The first electronic paper display 411α and the second electronic paper display 411β are disposed such that the third edge portions 411E3A of the first electronic paper display 411α and the second electronic paper display 411β are arranged next to (opposite) each other. The third electronic paper display 411γ and the fourth electronic paper display 411δ are disposed such that the third edge portions 411E3A of the third electronic paper display 411γ and the fourth electronic paper display 411δ are arranged next to (opposite) each other. The fifth electronic paper display 411ϵ and the sixth electronic paper display 411ζ are disposed such that the third edge portions 411E3C thereof are arranged next to (opposite) each other and are configured as one pair. The number of pairs of the fifth electronic paper display 411ϵ and the sixth electronic paper display 411ζ is n (n: natural number). A certain number of pairs (n pairs) of the fifth electronic paper display 411ϵ and the sixth electronic paper display 411ζ are disposed between the first electronic paper display 411α and the third electronic paper display 411γ and is disposed also between the second electronic paper display 411β and the fourth electronic paper display 411δ. The first electronic paper display 411α is disposed such that the third edge portion 411E3B of the first electronic paper display 411α is arranged next to (opposite) the third edge portion 411E3D of the fifth electronic paper display 411ϵ of the n pairs of the fifth electronic paper display 411ϵ and the sixth electronic paper display 411ζ. The third electronic paper display 411γ is disposed such that the third edge portion 411E3B of the third electronic paper display 411γ is arranged next to (opposite) the third edge portion 411E3E of the fifth electronic paper display 411ϵ of the n pairs of the fifth electronic paper display 411ϵ and the sixth electronic paper display 411ζ. The second electronic paper display 411β is disposed such that the third edge portion 411E3B of the second electronic paper display 411β is arranged next to (opposite) the third edge portion 411E3D of the sixth electronic paper display 411ζ of the n pairs of the fifth electronic paper display 411ϵ and the sixth electronic paper display 411ζ. The fourth electronic paper display 411δ is disposed such that the third edge portion 411E3B of the fourth electronic paper display 411δ is arranged next to (opposite) the third edge portion 411E3E of the sixth electronic paper display 411ζ of the n pairs of the fifth electronic paper display 411ϵ and the sixth electronic paper display 411ζ. The mirror surface reflection members 445 are disposed opposite the second edge portions of the first electronic paper display 411α, the second electronic paper display 411β, the third electronic paper display 411γ, and the fourth electronic paper display 411δ. With an image being displayed on the display surfaces 411A of the first electronic paper display 411α, the second electronic paper display 411β, the third electronic paper display 411γ, the fourth electronic paper display 411δ, the fifth electronic paper display 411ϵ, and the sixth electronic paper display 411ζ, which are arranged such that the third edge portions 411E3 are arranged next to each other, a screen size is increased. Furthermore, the mirror surface reflection members 445 are disposed opposite the second edge portions 411E2 of the first electronic paper display 411α, the second electronic paper display 411β, the third electronic paper display 411γ, and the fourth electronic paper display 411δ. Therefore, light use efficiency is improved.

### Other Embodiments

The technology described herein is not limited to the embodiments described above and illustrated by the drawings. For example, the following embodiments will be included in the technical scope of the present technology.
(1) In the configuration of each of the first embodiment and the second embodiment, multiple electronic paper displays 11, 111 may be arranged. The electronic paper displays 11, 111 may be arranged like the third to fifth embodiments or may be arranged in any other forms (such as the following (2) and (3)). The number of the electronic paper displays 11, 111 may be five, seven or more.
(2) In the configuration of the third embodiment, the two electronic paper displays may be arranged along the X-axis direction.
(3) In the configuration of the third embodiment, three or more electronic paper displays may be arranged along the Y-axis direction or the X-axis direction.
(4) In the configuration of the third embodiment, the louver 46 may have a width dimension that is about same as the thickness of the space S between the electronic paper display and the light transmissive panel 213 (the opening width of the opening 44D). In such a configuration, the louver 46 may be fitted in the opening 44D of the casing 44.
(5) In the configurations of the third to fifth embodiments, the mirror surface reflection member 245, 345, 445 may not be included.
(6) In the configurations of the fourth embodiment and the fifth embodiment, the louver 46 may not be included.
(7) In the configuration of the fifth embodiment, four rows or more of the electronic paper displays may be arranged along the Y-axis direction. Namely, two or more pairs of the fifth electronic paper display 411ϵ and the sixth electronic paper display 411ζ may be included (n may be two or greater). In such a configuration, the number of the electronic paper displays is eight or an even number greater than eight.
(8) The reflection surface 43A of the concave mirror 43 may not be a paraboloid.
(9) The display device 10, 200, 300, 400, 500 may be configured such that the outer edge portion extending along the X-axes direction (the long-side direction of the electronic paper display) may be the first edge portion 11E1, 111E1, 211E1, 311E1, 411E1. Namely, the casings 44 in which the LEDs 40, the LED boards 41, the reflection sheets 42, and the concave mirrors 43 are arranged may be disposed on the lateral side of (opposite) the edge portion of the electronic paper display extending along the X-axis direction.
(10) The electronic paper display of the front light device 12, 212, 312, 412 may include multiple first edge portions 11E1, 1111, 211E1, 311E1, 411E1. Namely, the casings 44 in each of which the LEDs 40, the LED boards 41, the reflection sheets 42, and the concave mirrors 43 are arranged may be disposed on the lateral side of multiple edge portions of the outer edge portion of each of the electronic paper displays.
(11) The front light device 12, 212, 312, 412 may not include the reflection sheet 42.
(12) the display device 10, 200, 300, 400, 500 may not include the light transmissive panel 13, 113, 213, 313, 413.
(13) A light guide plate through which light travels may be disposed in the space S between the electronic paper display and the light transmissive panel 13, 113, 213, 313, 413. Namely, the space S does not necessarily correspond to an air layer but an optical member such as a light guide plate may be disposed in the space S.
(14) The electronic paper display may not include the color filter 32. In such a case, a gray scale image or a black-and-white image are displayed on the display surface 11A, 111A, 211A, 311A, 411A.
(15) In the configuration of (14), the electronic paper display may display color images without using the color filter 32. For instance, with the microcapsule 30 including charged particles that exhibit different colors, color images can be displayed.
(16) The electronic paper layer 27 of the electronic paper display may be an electrophoretic display type (such as a microcup type, an In-plane type) other than the microcapsule type.
(17) A plan view shape of the electronic paper display may be a vertically long rectangle, a square, a trapezoid, a diamond shape, a polygonal shape such as a pentagon and a hexagon, a circle, a semicircle, a vertically long rectangle, and an oval.
(18) The display panel may be a reflective type liquid crystal panel or a semi-transmissive type liquid crystal panel other than the electronic paper display.

1. A lighting device comprising:
a light source having a light emitting surface through which light exits toward a surface of a light supplied object; and
a concave mirror disposed on a lateral side of the light supplied object and opposite the light emitting surface of the light source, the concave mirror having a reflection surface that reflects the light from the light source to be directed along the surface of the light supplied object.

2. The lighting device according to claim 1, further comprising a reflection member that extends from the light source to the concave mirror and reflects the light.

3. The lighting device according to claim 1, further comprising a louver that is disposed on a lateral side of the light supplied object and opposite the reflection surface, the louver including
at least two light blocking portions that are spaced away from each other in a normal direction to the surface, and
a light transmissive portion that is disposed between the at least two light blocking portions.

4. A display device comprising:
a display panel having a display surface where an image is displayed; and
a lighting device including
a light source having a light emitting surface through which light exits toward the display surface of the display panel, and
a concave mirror disposed on a lateral side of the display panel and opposite the light emitting surface of the light source, the concave mirror having a reflection surface that reflects the light from the light source to be directed along the display surface of the display panel.

5. The display device according to claim 4, wherein
the display panel includes an outer edge portion including a first edge portion,
the light source and the concave mirror are disposed on a lateral side of the first edge portion, and
the light source is disposed closer to the first edge portion than the concave mirror is.

6. The display device according to claim 5, further comprising a mirror surface reflection member that reflects light with specular reflection, wherein
the outer edge portion of the display panel further includes a second edge portion where the light source and the concave mirror are not disposed, and
the mirror surface reflection member is disposed on a lateral side of the second edge portion.

7. The display device according to claim 6, wherein
the display panel has a rectangular shape and the outer edge portion includes the first edge portion and three second edge portions including the second edge portion, and
the mirror surface reflection member includes mirror surface reflection members that are disposed on a lateral side of the three second edge portions, respectively.

8. The display device according to claim 6, wherein
the display panel includes display panels including a first display panel and a second display panel,
the first display panel and the second display panel have a rectangular shape,
the outer edge portion of each of the first display panel and the second display panel includes the first edge portion, two second edge portions including the second edge portion, and a third edge portion where the light source, the concave mirror, and the mirror surface member are not disposed,
the first display panel and the second display panel are disposed such that the third edge portions thereof are arranged next to each other, and
the mirror surface reflection member includes mirror surface reflection members that are disposed on the lateral side of the two second edge portions of each of the first display panel and the second display panel.

9. The display device according to claim 6, wherein
the display panel includes display panels including a first display panel, a second display panel, a third display panel, and a fourth display panel,
the first display panel, the second display panel, the third display panel, and the fourth display panel have a rectangular shape,
the outer edge portion of each of the first display panel, the second display panel, the third display panel, and the fourth display panel includes the first edge portion, the second edge portion, and two third edge portions where the light source, the concave mirror, and the mirror surface member are not disposed, the two third edge portions including one third edge portion and other third edge portion, and
the first display panel and the second display panel are disposed such that the one third edge portions thereof are arranged next to each other,
the third display panel and the fourth display panel are disposed such that the one third edge portions thereof are arranged next to each other,
the first display panel and the third display panel are disposed such that the other third edge portions thereof are arranged next to each other,
the second display panel and the fourth display panel are disposed such that the other third edge portions thereof are arranged next to each other, and
the mirror surface reflection member includes mirror surface reflection members that are disposed on the lateral side of the second edge portions of the first display panel, the second display panel, the third display panel, and the fourth display panel.

10. The display device according to claim 6, wherein
the display panel includes display panels including a first display panel, a second display panel, a third display panel, a fourth display panel, a fifth display panel, and a sixth display panel,
the first display panel, the second display panel, the third display panel, the fourth display panel, the fifth display panel, and the sixth display panel have a rectangular shape,
the outer edge portion of each of the first display panel, the second display panel, the third display panel, and the fourth display panel includes the first edge portion, the second edge portion, and two third edge portions where the light source, the concave mirror, and the mirror surface member are not disposed, the two third edge portions including one third edge portion and other third edge portion,
the outer edge portion of each of the fifth display panel and the sixth display panel includes the first edge portion and three third edge portions where the light source, the concave mirror, and the mirror surface member are not disposed, the three third edge portions including one third edge portion, a first opposed third edge portion, and a second opposed third edge portion,
the first display panel and the second display panel are disposed such that the one third edge portions thereof are arranged next to each other,
the third display panel and the fourth display panel are disposed such that the one third edge portions thereof are arranged next to each other,
the fifth display panel and the sixth display panel are disposed such that the one third edge portions thereof are arranged next to each other,
the fifth display panel is disposed between the first display panel and the third display panel and the sixth display panel is disposed between the second display panel and the fourth display panel,
the first display panel is disposed such that the other third edge portion is arranged next to the first opposed third edge portion of the fifth display panel,
the third display panel is disposed such that the other third edge portion is arranged next to the second opposed third edge portion of the fifth display panel,
the second display panel is disposed such that the other edge portion is arranged next to the first opposed third edge portion of the sixth display panel,
the fourth display panel is disposed such that the other edge portion is arranged next to the second opposed third edge portion of the sixth display panel, and
the mirror surface reflection member includes mirror surface reflection members that are disposed on the lateral side of the second edge portions of the first display panel, the second display panel, the third display panel, and the fourth display panel.

11. The display device according to claim 4, further comprising a light transmissive panel that has an opposed surface facing the display surface and is disposed to be away from the display panel with having a space between the display surface and the opposed surface, wherein
the concave mirror is disposed such that the reflection surface faces the space.

12. The display device according to claim 4, wherein the display panel is an electronic paper display.
